(19) United States
(12) Patent Application Publication
(10) Pub. No.: US 2026/0252189 A1
(43) Pub. Date: Aug. 27, 2026

(54) HYBRID AND/OR FULL IN-CELL SYSTEM WITH MULTI-FREQUENCY SENSING SYSTEM

(71) Applicant: Synaptics Incorporated, San Jose, CA (US)

(72) Inventors: Daisuke Ito, Tokyo (JP); Guozhong Shen, Fremont, CA (US); Masaaki Shiomura, Tokyo (JP)

(21) Appl. No.: 19/529,613

(22) Filed: Feb. 4, 2026

Related U.S. Application Data
(60) Provisional application No. 63/816,717, filed on Jun. 3, 2025.
(60) Provisional application No. 63/762,703, filed on Feb. 25, 2025.

(51) Int. Cl. G06F 3/041; G06F 3/044

(52) U.S. Cl. CPC G06F 3/04164; G06F 3/0412; G06F 3/04166; G06F 3/0445

(57) ABSTRACT

A method for performing a multi-frequency transmitter electrode driving scheme. The method comprises driving, by a processing system of an input device, a plurality of transmitter electrodes using a plurality of frequencies. A first subset of the plurality of transmitter electrodes is driven using a first frequency and a second subset of the plurality of transmitter electrodes is driven using a second frequency. The input device comprises a hybrid in-cell sensor comprising a thin film transistor (TFT) glass layer and a color filter glass layer. The plurality of transmitter electrodes are positioned on a first side of the TFT glass layer and a plurality of receiver electrodes are positioned on a first side of the color filter glass layer. The method further comprises obtaining resulting signals and determining a presence of an input object on a sensing region of the input device based on the resulting signals.

### CROSS-REFERENCE TO RELATED APPLICATIONS

This application claims priority to U.S. Provisional Patent Application No. 63/762,703, entitled “HYBRID IN-CELL WITH MULTI-FREQUENCY SENSING SYSTEM,” filed February 25, 2025 and U.S. Provisional Patent Application No. 63/816,717, entitled “HYBRID AND/OR FULL IN-CELL SYSTEM WITH MULTI-FREQUENCY SENSING SYSTEM,” filed June 3, 2025. Both of which are incorporated by reference herein in their entirety.

### TECHNICAL FIELD

This disclosure relates generally to operating an input device having a display device with an integrated sensing device.

### BACKGROUND

Input devices including proximity sensor devices (e.g., touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (e.g., opaque touchpads integrated in, or peripheral to, notebook or desktop computers). Proximity sensor devices are also often used in smaller computing systems (e.g., touch screens integrated in cellular phones).

Traditionally, systems driven by conventional non-multi frequency sensing (e.g., where all of the sensor electrodes such as touch pixel electrodes share a common electrode (Vcom) layer) typically utilize an absolute touch sensing scheme. However, the absolute touch sensing scheme cannot utilize nor support multi-frequency sensing. For instance, in the case of the absolute touch sensing scheme, in order to mitigate the background capacitance, all sensors may be modulated by the same phases and same frequencies. Without having all of the sensors modulated by the same phases and frequencies, a false touch detection that is caused by noise may result. Therefore, to reduce touch time budgets, these systems generally include additional analog front-ends (AFEs), which increases the cost of the overall system (e.g., the application-specific integrated circuits (ASICs)). Furthermore, by including additional AFEs, the power consumption of these systems is increased significantly as well. As such, there remains a technical need to utilize other technologies and systems to reduce the touch time budgets and power consumption.

### SUMMARY

This summary is provided to introduce a selection of concepts in a simplified form that are further described below. This summary is not intended to necessarily identify key features or essential features of the present disclosure. The present disclosure may include the following various aspects and embodiments.

In an exemplary embodiment, the present disclosure provides an input device for performing a multi-frequency transmitter electrode driving scheme. The input device comprises a hybrid in-cell sensor comprising: a thin film transistor (TFT) glass layer and a color filter glass layer; a plurality of transmitter electrodes that are positioned on a first side of the TFT glass layer; a plurality of receiver electrodes that are positioned on a first side of the color filter glass layer. The input device further comprises a processing system configured to: drive the plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency; obtain resulting signals from the plurality of receiver electrodes based on driving the plurality of transmitter electrodes using the plurality of frequencies; and determine a presence of an input object on a sensing region of the input device based on the resulting signals.

In another exemplary embodiment, the present disclosure provides a method for performing a multi-frequency transmitter electrode driving scheme, comprising: driving, by a processing system of an input device, a plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency, wherein the input device comprises a hybrid in-cell sensor comprising a thin film transistor (TFT) glass layer and a color filter glass layer, and wherein the plurality of transmitter electrodes are positioned on a first side of the TFT glass layer and a plurality of receiver electrodes are positioned on a first side of the color filter glass layer; obtaining, by the processing system, resulting signals from the plurality of receiver electrodes based on driving the plurality of transmitter electrodes using the plurality of frequencies; and determining, by the processing system, a presence of an input object on a sensing region of the input device based on the resulting signals.

In yet another exemplary embodiment, the present disclosure provides a non-transitory computer-readable medium having processor-executable instructions stored thereon for performing a multi-frequency transmitter electrode driving scheme. The processor-executable instructions, when executed, facilitating performance of the following: driving, using a processing system of an input device, a plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency, wherein the input device comprises a hybrid in-cell sensor comprising a thin film transistor (TFT) glass layer and a color filter glass layer, and wherein the plurality of transmitter electrodes are positioned on a first side of the TFT glass layer and a plurality of receiver electrodes are positioned on a first side of the color filter glass layer; obtaining resulting signals from the plurality of receiver electrodes based on driving the plurality of transmitter electrodes using the plurality of frequencies; and determining a presence of an input object on a sensing region of the input device based on the resulting signals.

In yet another exemplary embodiment, the present disclosure provides an input device for performing a multi-frequency transmitter electrode driving scheme comprising a full in-cell sensor and a processing system. The full in-cell sensor comprises a plurality of transmitter electrodes that are bar electrodes and positioned in a first direction; a plurality of receiver electrodes that are bar electrodes and positioned in a second direction that is perpendicular to the first direction; and a thin film transistor (TFT) circuitry layer, wherein the plurality of transmitter electrodes and the plurality of receiver electrodes are located within the TFT circuitry layer. The processing system is configured to: drive the plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency; obtain resulting signals from the plurality of receiver electrodes based on driving the plurality of transmitter electrodes using the plurality of frequencies; and determine a presence of an input object on a sensing region of the input device based on the resulting signals.

In yet another exemplary embodiment, the present disclosure provides a method for performing a multi-frequency transmitter electrode driving scheme. The method comprises: driving, by a processing system of an input device, a plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency, wherein the input device comprises a full in-cell sensor comprising a thin film transistor (TFT) circuitry layer, wherein the plurality of transmitter electrodes and a plurality of receiver electrodes are located within the TFT circuitry layer, wherein the plurality of transmitter electrodes are bar electrodes and the plurality of receiver electrodes are bar electrodes that are oriented perpendicular to each other; obtaining, by the processing system, resulting signals from the plurality of receiver electrodes based on driving the plurality of transmitter electrodes using the plurality of frequencies; and determining, by the processing system, a presence of an input object on a sensing region of the input device based on the resulting signals.

In yet another exemplary embodiment, the present disclosure provides a non-transitory computer-readable medium having processor-executable instructions stored thereon for performing a multi-frequency transmitter electrode driving scheme. The processor-executable instructions, when executed, facilitating performance of the following: driving, using a processing system of an input device, a plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency, wherein the input device comprises a full in-cell sensor comprising a thin film transistor (TFT) circuitry layer, wherein the plurality of transmitter electrodes and a plurality of receiver electrodes are located within the TFT circuitry layer, wherein the plurality of transmitter electrodes are bar electrodes that are positioned in a first direction, and wherein the plurality of receiver electrodes are bar electrodes that are positioned in a second direction that is perpendicular to the first direction; obtaining resulting signals from the plurality of receiver electrodes based on driving the plurality of transmitter electrodes using the plurality of frequencies; and determining a presence of an input object on a sensing region of the input device based on the resulting signals.

Further features and aspects are described in additional detail below with reference to the FIGs.

### BRIEF DESCRIPTION OF THE DRAWINGS

FIG. 1 illustrates a schematic block diagram of an input device according to one or more examples of the present disclosure.

FIG. 2 illustrates a portion of an exemplary sensor electrode arrangement according to one or more examples of the present disclosure.

FIG. 3 illustrates an exemplary sensor electrode arrangement within a plurality of layers of an input device according to one or more examples of the present disclosure.

FIG. 4 illustrates an exemplary multi-frequency direct transmitter electrode driving scheme according to one or more examples of the present disclosure.

FIG. 5 illustrates an exemplary multi-frequency transmitter electrode driving scheme at the display panel according to one or more examples of the present disclosure.

FIGS. 6A-6C illustrate exemplary multi-frequency vertical transmitter electrode driving schemes according to one or more examples of the present disclosure.

FIGS. 7A-7B illustrate additional multi-frequency transmitter electrode driving schemes according to one or more examples of the present disclosure.

FIG. 8 is a flowchart of an exemplary process for performing a multi-frequency transmitter electrode driving scheme according to one or more examples of the present disclosure.

FIG. 9A illustrates exemplary sensor electrode arrangements according to one or more examples of the present disclosure.

FIG. 9B illustrates an exemplary full in-cell system that includes transmitter and receiver electrodes within a thin-film transistor (TFT) circuitry layer according to one or more examples of the present disclosure.

FIG. 10 illustrates exemplary architectures of the full in-cell system that includes transmitter and receiver electrodes within the TFT circuitry layer according to one or more examples of the present disclosure.

FIG. 11 illustrates an exemplary multi-frequency direct transmitter electrode driving scheme using the full in-cell system according to one or more examples of the present disclosure.

FIG. 12 illustrates an exemplary multi-frequency transmitter electrode driving scheme at the display panel using the full in-cell system according to one or more examples of the present disclosure.

FIGS. 13A-13B illustrate additional multi-frequency transmitter electrode driving schemes using the full in-cell system according to one or more examples of the present disclosure.

FIG. 14 is a flowchart of another exemplary process for performing a multi-frequency transmitter electrode driving scheme according to one or more examples of the present disclosure.

### DETAILED DESCRIPTION

The following detailed description is exemplary in nature and is not intended to limit the disclosure or the application and uses of the disclosure. Furthermore, there is no intention to be bound by any expressed or implied theory presented in the preceding background, summary and brief description of the drawings, or the following detailed description.

In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

Various examples of the present disclosure provide multi-frequency sensing schemes for hybrid in-cell systems (e.g., hybrid in-cell liquid crystal display (LCD) systems). For example, in contrast to a full-advanced matrix pad (AMP) in-cell system, a hybrid in-cell system may include the Rx electrode positioned on top of the color filter glass and the transmitter (Tx) electrode positioned on top of the thin-film transistor (TFT) glass layer. The Rx and Tx electrodes may share a Vcom layer. It is shown that the hybrid in-cell system may be configured to utilize multi-frequency sensing, which provides significant advantages over traditional systems and methods. For example, the in-cell system may perform time sharing (e.g., have a same time budget such as a set number of frames) between the display and touch functionalities and, therefore, reducing the touch time budget (e.g., reducing the time budget or number of frames that are used for touch functionalities by a factor of three) may provide improved display performance (e.g., additional frames would be made available for the display functionalities). To reduce the touch time budget and increase the display performance, various examples of the present disclosure may utilize multi-frequency sensing for hybrid in-cell systems. For instance, based on using multiple frequencies (e.g., three separate frequencies), the touch time budget for performing the touch sensing scheme may be reduced significantly (e.g., by a factor of three), which would improve the display performance. In addition, the usage of the multi-frequency sensing for hybrid in-cell systems may further facilitate supporting of a much larger (e.g., increased width and height dimensions that include additional sensor electrodes) touch screen. For instance, using the same time budget, a larger touch screen may be supported by the hybrid in-cell systems based on utilizing the multi-frequency sensing. In addition, hybrid in-cell systems may allow for lower power consumption as well when using the multi-frequency sensing. This will be described in further detail below.

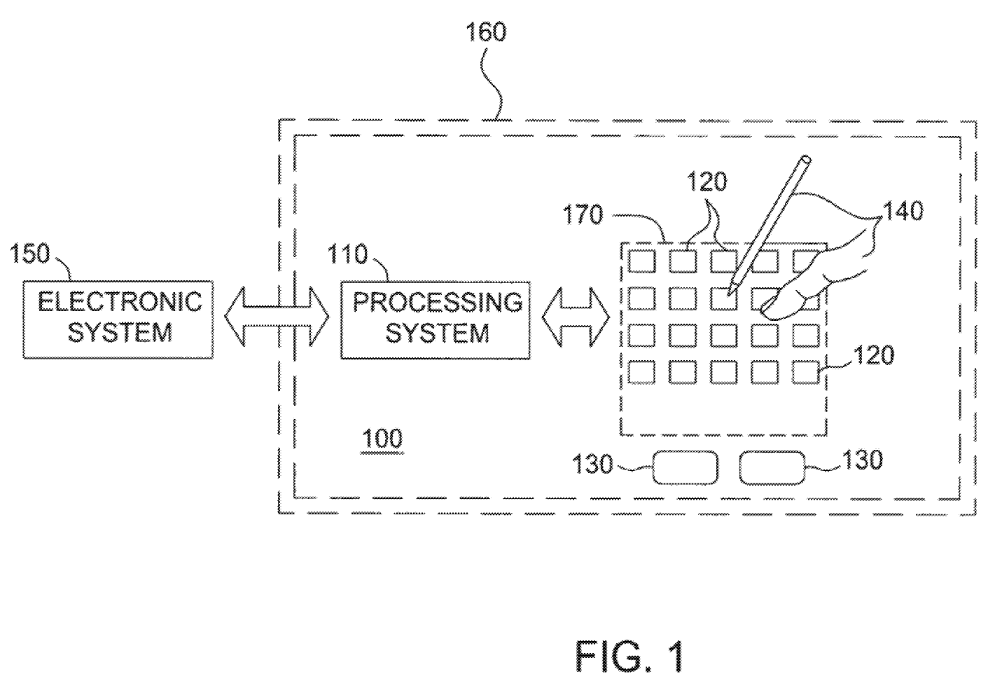

FIG. 1 illustrates a schematic block diagram of an input device 100 according to one or more examples of the present disclosure. In various examples, input device 100 comprises a display device integrated with a sensing device. The input device 100 may be configured to provide input to an electronic system 150. As used herein, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 may be implemented as a physical part of the electronic system or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 170. Example input objects include fingers and styli, as shown in FIG. 1.

Sensing region 170 encompasses any space above, around, in, on, and/or near the input device 100 in which the input device 100 is able to detect user input (e.g., user input provided by one or more input objects 140). The sizes, shapes, and locations of particular sensing regions may vary widely from example to example. In some examples, the sensing region 170 extends from a surface of the input device 100 in one or more directions into space until signal-to-noise ratios prevent sufficiently accurate object detection. The distance to which this sensing region 170 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 170 has a rectangular shape when projected onto an input surface of the input device 100.

The input device 100 may utilize any combination of sensor components and sensing technologies to detect user input in the sensing region 170. The input device 100 comprises a plurality of sensor electrodes 120 for detecting user input. The input device 100 may include one or more sensor electrodes 120 that are combined to form sensor electrodes. As several non-limiting examples, the input device 100 may use capacitive, elastive, resistive, inductive, magnetic acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensor electrodes 120 pickup loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensor electrodes 120 to create electric fields. In some implementations, separate sensor electrodes 120 may be ohmically shorted together to form larger sensor electrodes. Some capacitive implementations utilize resistive sheets, which may be uniformly resistive.

As discussed above, some capacitive implementations utilize “self-capacitance” (or “absolute capacitance”) sensing methods based on changes in the capacitive coupling between sensor electrodes 120 and an input object. In one embodiment, processing system 110 is configured to drive a voltage with known amplitude onto the sensor electrode 120 and measure the amount of charge required to charge the sensor electrode to the driven voltage. In other embodiments, processing system 110 is configured to drive a known current and measure the resulting voltage. In various embodiments, an input object near the sensor electrodes 120 alters the electric field near the sensor electrodes 120, thus changing the measured capacitive coupling. In one implementation, an absolute capacitance sensing method operates by modulating sensor electrodes 120 with respect to a reference voltage (e.g. system ground) using a modulated signal, and by detecting the capacitive coupling between the sensor electrodes 120 and input objects 140.

Additionally as discussed above, some capacitive implementations utilize “mutual capacitance” (or “transcapacitance”) sensing methods based on changes in the capacitive coupling between sensing electrodes. In various embodiments, an input object 140 near the sensing electrodes alters the electric field between the sensing electrodes, thus changing the measured capacitive coupling. In one implementation, a transcapacitive sensing method operates by detecting the capacitive coupling between one or more transmitter sensing electrodes (also “transmitter electrodes”) and one or more receiver sensing electrodes (also “receiver electrodes”) as further described below. Transmitter sensing electrodes may be modulated relative to a reference voltage (e.g., system ground) to transmit a transmitter signals. Receiver sensing electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensing electrodes may be dedicated transmitter electrodes or receiver electrodes, or may be configured to both transmit and receive.

In FIG. 1, the processing system 110 is shown as part of the input device 100. The processing system 110 is configured to operate the hardware of the input device 100 to detect input in the sensing region 170. The processing system 110 comprises parts of or all of one or more integrated circuits (ICs) and/or other circuitry components. For example, a processing system for a mutual capacitance sensor device may comprise transmitter circuitry configured to transmit signals with transmitter (Tx) sensor electrodes, and/or receiver circuitry configured to receive signals with receiver (Rx) sensor electrodes. In some embodiments, the processing system 110 also comprises electronically-readable instructions, such as firmware code, software code, and/or the like. In some embodiments, components composing the processing system 110 are located together, such as near sensor electrode(s) 120 of the input device 100. In other embodiments, components of processing system 110 are physically separate with one or more components close to sensor electrode(s) 120 of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensor electrodes 120 to detect input, identification modules configured to identify gestures such as mode changing gestures, and mode changing modules for changing operation modes. Processing system 110 may also comprise one or more controllers.

In some embodiments, the processing system 110 responds to user input (or lack of user input) in the sensing region 170 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensor electrode(s) 120 of the input device 100 to produce electrical signals indicative of input (or lack of input) in the sensing region 170. The processing system 110 may perform any appropriate amount of processing on the electrical signals in producing the information provided to the electronic system. For example, the processing system 110 may digitize analog electrical signals obtained from the sensor electrodes 120. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 170, or some other functionality. FIG. 1 shows buttons 130 near the sensing region 170 that may be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 170 overlaps at least part of an active area of a display screen of the display device 160. For example, the input device 100 may comprise substantially transparent sensor electrodes 120 overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display device 160 may share physical elements. For example, some embodiments may utilize some of the same electrical components for displaying and sensing. As another example, the display device 160 may be operated in part or in total by the processing system 110.

It should be understood that while many embodiments of the present technology are described in the context of a fully functioning apparatus, the mechanisms of the present technology are capable of being distributed as a program product (e.g., software) in a variety of forms. For example, the mechanisms of the present technology may be implemented and distributed as a software program on information bearing media that are readable by electronic processors (e.g., non-transitory computer-readable and/or recordable/writable information bearing media readable by the processing system 110). Additionally, the embodiments of the present technology apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

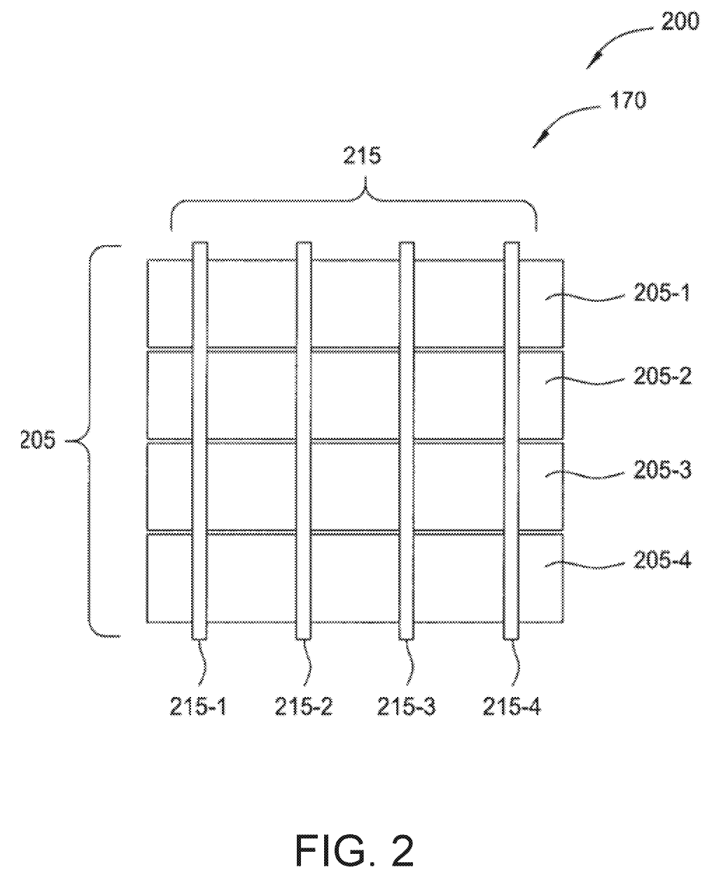

Exemplary sensor electrode arrangements are described in further detail below. For instance, FIG. 2 illustrates a portion of an exemplary sensor electrode arrangement 200 according to one or more examples of the present disclosure. Specifically, sensor electrode arrangement 200 illustrates a portion of a pattern of sensor electrodes configured to sense in a sensing region 170 associated with the pattern, according to several embodiments. For clarity of illustration and description, FIG. 2 shows the sensor electrodes in a pattern of simple rectangles (e.g., bar sensor electrodes), and does not show various associated components. This pattern of sensing electrodes comprises a first plurality of sensor electrodes 205 (e.g., 205-1, 205-2, 205-3, 205-4), and a second plurality of sensor electrodes 215 (e.g., 215-1, 215-2, 215-3, 215-4). The first and second pluralities of sensor electrodes 205 and 215, respectively, are each examples of the sensor electrodes 120 described above. In one embodiment, processing system 110 operates the first plurality of sensor electrodes 205 as a plurality of transmitter electrodes, and the second plurality of sensor electrodes 215 as a plurality of receiver electrodes. In another embodiment, processing system 110 operates the first plurality of sensor electrodes 205 and the second plurality of sensor electrodes 215 as absolute capacitive sensing electrodes.

The first plurality of sensor electrodes 205 and the second plurality of sensor electrodes 215 are typically ohmically isolated from each other. That is, one or more insulators separate the first plurality of sensor electrodes 205 and the second plurality of sensor electrodes 215 and prevent them from electrically shorting to each other. In some embodiments, the first plurality of sensor electrodes 205 and the second plurality of sensor electrodes 215 may be disposed on a common layer (e.g., a Vcom layer). The pluralities of sensor electrodes 205 and 215 may be electrically separated by insulative material disposed between them at cross-over areas; in such constructions, the first plurality of sensor electrodes 205 and/or the second plurality of sensor electrodes 215 may be formed with jumpers connecting different portions of the same electrode. In some embodiments, the first plurality of sensor electrodes 205 and the second plurality of sensor electrodes 215 are separated by one or more layers of insulative material. In some embodiments, the first plurality of sensor electrodes 205 and the second plurality of sensor electrodes 215 are separated by one or more substrates; for example, they may be disposed on opposite sides of the same substrate, or on different substrates that are laminated together

The first and second pluralities of sensor electrodes 205, 215 may be formed into any desired shapes. Moreover, the size and/or shape of the first plurality of sensor electrodes 205 may be different than the size and/or shape of the second plurality of sensor electrodes 215. Additionally, the first and second pluralities of sensor electrodes 205, 215 located on a same side of a substrate may have different shapes and/or sizes. In one embodiment, the first plurality of sensor electrodes 205 may be larger (e.g., having a larger surface area) than the second plurality of sensor electrodes 215, although this is not a requirement. In other embodiments, the first and second pluralities of sensor electrodes 205, 215 may have a similar size and/or shape.

In one embodiment, the first plurality of sensor electrodes 205 extends substantially in a first direction (e.g., vertical direction) while the second plurality of sensor electrodes 215 extends substantially in a second direction (e.g., horizontal direction). For example, and as shown in FIG. 2, the first plurality of sensor electrodes 205 extend in one direction, while the second plurality of sensor electrodes 215 extend in a direction substantially orthogonal to the first plurality of sensor electrodes 205. Other orientations are also possible (e.g., parallel or other relative orientations).

In some embodiments, both the first and second pluralities of sensor electrodes 205, 215 are located outside of a plurality (or display stack) of layers that together form the display device 160. One example of a display stack may include layers such as a lens layer, a one or more polarizer layers, a color filter layer, one or more display electrodes layers, a display material layer, a thin-film transistor (TFT) glass layer, and a backlight layer. However, other arrangements of a display stack are possible. In other embodiments, one or both of the first and second pluralities of sensor electrodes 205, 215 are located within the display stack, whether included as part of a display-related layer or a separate layer. For example, Vcom electrodes within a particular display electrode layer may be configured to perform both display updating and capacitive sensing.

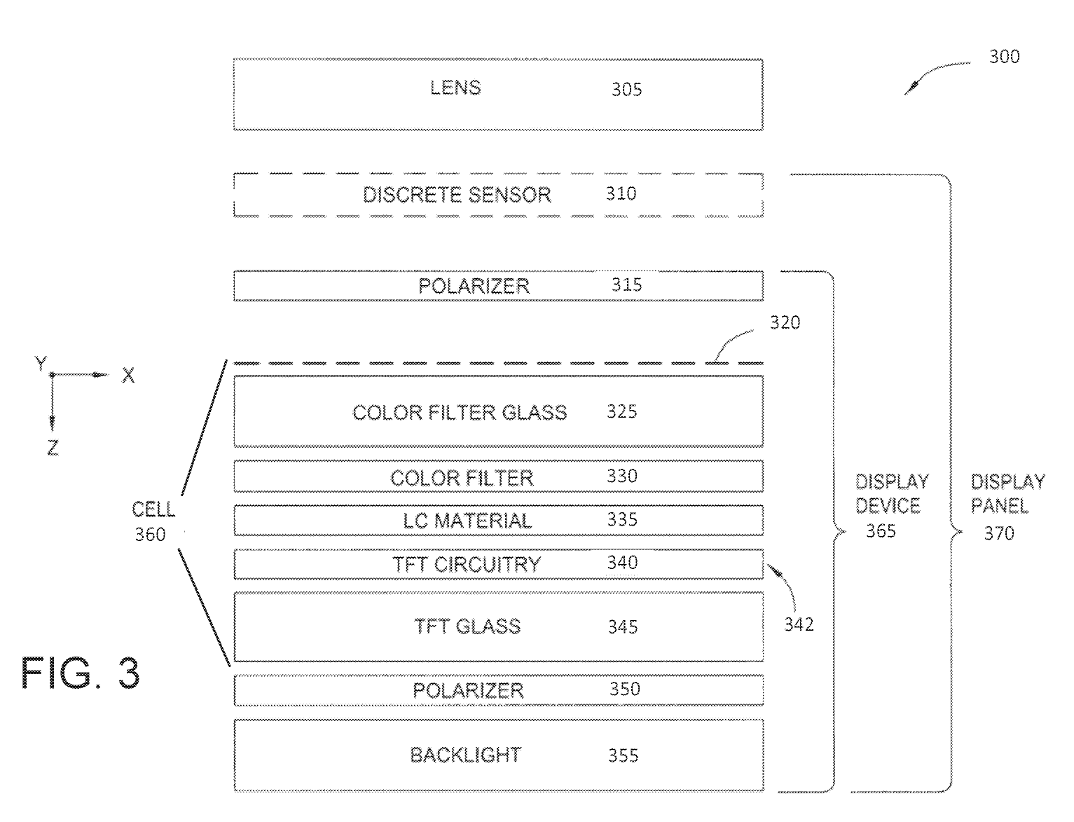

An exemplary multiple-layer arrangement of a hybrid in-cell system (e.g., an input device 100 having a hybrid in-cell sensor) is described below. For instance, FIG. 3 illustrates an exemplary sensor electrode arrangement within a plurality of layers of an input device according to one or more examples of the present disclosure. More specifically, FIG. 3 provides a cross-sectional view of an input device 300 comprising a display device 365. Note that the various layers depicted within the input device 300 are not drawn to scale, and the layers may be laminated together or otherwise connected within the input device 300. The depicted input device 300 is meant as one non-limiting example, as suitable alternate arrangements of the input device 300 can include more or less layers, may arrange the layers with a different order, etc.

The display device 365 comprises a plurality of layers beneath a lens layer 305. The lens layer 305 (e.g., a cover lens) is generally optically transmissive and may be formed of glass, plastic, or other suitable material. In some instances, the display device 365 is included as part of a display panel 370 having a discrete sensor layer 310 disposed between the lens layer 305 and the display device 365. As shown, the display device 365 includes a polarizer layer 315, a color filter glass layer 325, a color filter layer 330, a liquid crystal (LC) material layer 335, a thin-film transistor (TFT) circuitry layer 340, a TFT glass layer 345, a polarizer layer 350, and a backlight layer 355. The TFT circuitry layer 340 may alternately be referred to as a display activation layer. In some OLED implementations of the display device 365, the TFT glass layer 345 may be replaced with a flexible material. Further, some OLED implementations may selectively emit different colored light, such that the color filter glass layer 325 and/or color filter layer 330 are not required.

As shown, a first layer 320 of sensor electrodes (e.g., a first subset of the sensor electrodes 120) is disposed between the color filter glass layer 325 and the polarizer layer 315. In some embodiments, the sensor electrodes of the first layer 320 may be deposited onto the color filter glass layer 325. In some embodiments, the sensor electrodes of the first layer 320 are formed of an optically transmissive conductive material, such as indium tin oxide (ITO). In other embodiments, the sensor electrodes of the first layer 320 are formed of a non-transmissive conductive material but arranged in such a manner as to be substantially optically transmissive. For example, the sensor electrodes may be formed as a wire mesh having suitably small wire strands (e.g., on the order of 0.5 to approximately 10 microns) disposed with a suitably large spacing between adjacent wire strands. In some examples, the first layer 320 of sensor electrodes may be Rx electrodes, which are described above.

A second layer 342 of sensor electrodes (e.g., a second subset of the sensor electrodes 120) is included within the TFT circuitry layer 340 and/or deposited onto the TFT glass layer 345. In some examples, the second layer 342 of sensor electrodes may be Tx electrodes, which are described above. In some variations, the TFT circuitry layer 340 comprises a plurality of common electrodes (Vcom) of the display device 365. In some embodiments, and as shown, a display cell 360 (e.g., a hybrid in-cell) is defined between color filter glass layer 325 and TFT glass layer 345. The first layer 320 of sensor electrodes is disposed outside of the display cell 360, and the second layer 342 of sensor electrodes is disposed within the display cell 360. In alternate embodiments, the first layer 320 of sensor electrodes may be disposed at an alternate location within the display cell 360, e.g., between color filter glass layer 325 and TFT glass layer 345.

As mentioned above, the TFT circuitry layer 340 may include Tx electrodes (e.g., the second layer 342 of sensor electrodes) that are used for the touch functionality and Vcom electrodes that are used for the display functionality. In some instances, the touch functionality and the display functionality may use the same electrodes. In other words, the second layer 342 of sensor electrodes may include electrodes that are the Tx electrodes as well as the Vcom electrodes (e.g., the second layer 342 of sensor electrodes may be used for touch functionality and display functionality). For instance, in a hybrid in-cell system comprising a hybrid in-cell (e.g., the display cell 360), the same electrode (e.g., an electrode from the second layer 342) may be used for touch and display functionality based on utilizing a time divided system. For example, the electrode may operate as a touch Tx electrode (or Rx electrode) during the touch period (e.g., a time period allocated for the touch functionality) and may operate as a display Vcom electrode during the display period (e.g., a time period allocated for the display functionality).

In some examples, based on utilizing the hybrid in-cell, the processing system 110 of FIG. 1 may be able to use a multi-frequency sensing scheme. For example, referring back to FIG. 1, the processing system 110 may be coupled to the sensor electrodes 120 (e.g., the first layer 320 and second layer 342 of sensor electrodes) and may include sensor circuitry and/or display driver circuitry. The sensor circuitry and/or display driver circuitry may be part of a larger processing system 110 that further comprises firmware, software, and/or other hardware elements. The sensor circuitry includes circuitry configured to drive at least one of the sensor electrodes (e.g., a sensor electrode from the second layer 342 of sensor electrodes) for capacitive sensing during periods in which input sensing is desired. In some embodiments, the sensor circuitry is configured to drive a signal (e.g., a Tx signal) onto at least one sensor electrode (e.g., a sensor electrode from the second layer 342) to detect changes between the at least one sensor electrode and another sensor electrode (e.g., a sensor electrode from the first layer 320).

In some examples, synchronization signals (e.g., Vsync) may be shared between the sensor circuitry and display driver circuitry to provide accurate control of overlapping display updating (e.g., display functionalities) and capacitive sensing periods (e.g., touch sensing functionalities) with repeatably coherent frequencies and phases. In one embodiment, these synchronization signals may be configured to allow the relatively stable voltages at the beginning and end of the input sensing period to coincide with display update periods with relatively stable voltages (e.g., near the end of an input integrator reset time and near the end of a display charge share time).

The sensor circuitry includes circuitry configured to receive resulting signals from the sensor electrodes 120 and/or grid electrode(s) comprising effects corresponding to the driving signals during periods in which input sensing is desired. The sensor circuitry may determine a position of the input object in the sensing region 170 or may provide a signal including information indicative of the resulting signal to another module or processor, for example, a determination circuitry or a processor of an associated electronic system 150 (i.e., a host processor), for determining the position of the input object in the sensing region 170.

The display driver circuitry may be included in or separate from the processing system 110. The display driver circuitry includes circuitry configured to provide display image update information to the display of the display device 160 during non-sensing (e.g., display updating) periods.

In some examples, the processing system 110 comprises a first integrated controller comprising the display driver circuitry and at least a portion of the sensor circuitry (e.g., Tx module and/or Rx module). In another embodiment, the processing system 110 comprises a first integrated controller comprising the display driver circuitry and a second integrated controller comprising the sensor circuitry. In yet another embodiment, the processing system 110 comprises a first integrated controller comprising display driver circuitry and a first portion of the sensor circuitry (e.g., one of a Tx module and a Rx module) and a second integrated controller comprising a second portion of the sensor circuitry (e.g., the other one of the Tx and Rx modules). In those embodiments comprising multiple integrated circuits, a synchronization mechanism may be coupled between them, configured to synchronize display updating periods, sensing periods, Tx signals, display update signals, and the like.

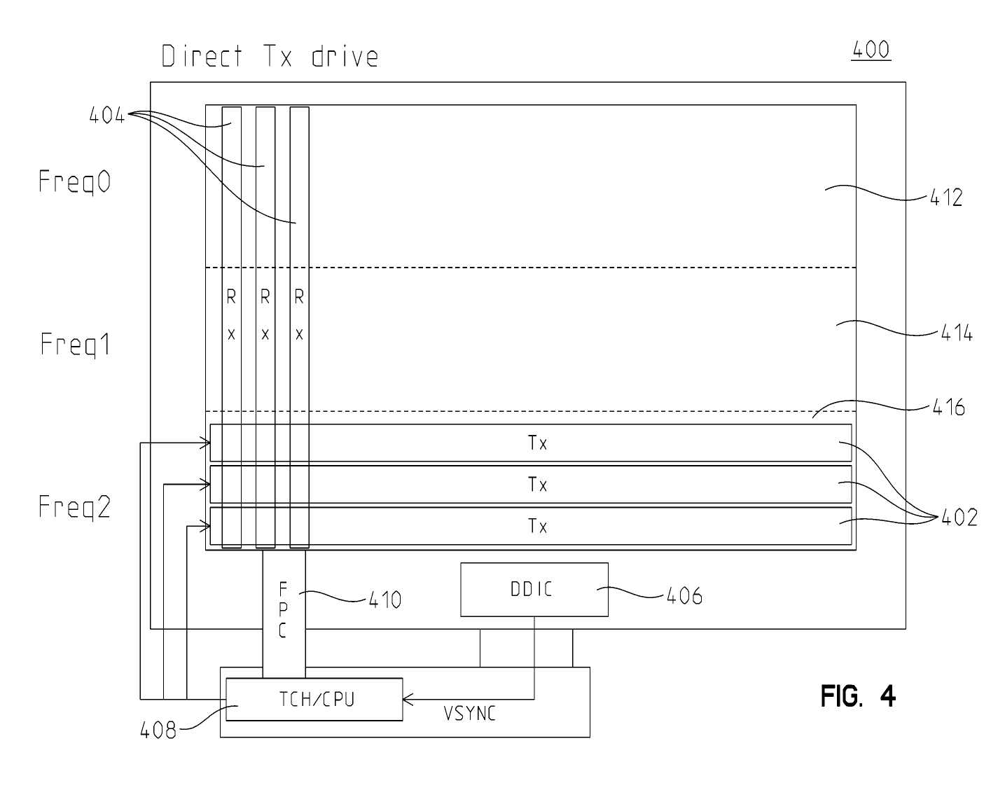

As will be described below in FIGS. 4-7B, the first layer 320 of sensor electrodes (e.g., sensor electrodes 120) may be the Rx electrodes and the second layer 342 of sensor electrodes may be the Tx electrodes. In addition, the processing system 110 may include a sensor circuitry, which may be a touch controller and/or processor (e.g., a touch (TCH) / central processing unit (CPU) that is shown in FIGS. 4-7B). The processing system 110 may further include display driver circuitry, which may be a display driver integrated circuit (DDIC) that is shown in FIGS. 4-7B.

FIG. 4 illustrates an exemplary multi-frequency direct Tx electrode driving scheme 400 according to one or more examples of the present disclosure. For instance, the multi-frequency direct Tx electrode driving scheme 400 may be a direct Tx drive scheme that is configured to directly drive the Tx electrodes (e.g., the second layer 342 of sensor electrodes) using the touch controller 408 (e.g., the TCH/CPU). FIG. 4 shows three regions 412-416, three Tx electrodes 402, and three Rx electrodes 404. While only three Tx electrodes 402 are shown for the region 416, as will be described below, the region 416 may include any number of Tx electrodes 402. In addition, for clarity, only the three Tx electrodes 402 for region 416 are shown, but the regions 412-414 may further include Tx electrodes 402. Similarly, only three Rx electrodes 404 are shown in FIG. 4 for clarity, but there may be any number of Rx electrodes 404 and the Rx electrodes 404 may span the entire length of the input device 100. For example, as mentioned previously, an input device 100 may include a sensor electrode arrangement such as the sensor electrode arrangement 200 shown in FIG. 2, and the sensor electrode arrangement may include bar electrodes (e.g., vertical and horizontal bar electrodes such as the first and second pluralities of electrodes 205 and 215). Referring back to FIGS. 3 and 4, a first set of electrodes (e.g., a set of electrodes that are oriented in a first direction such as a vertical direction) may be the Rx electrodes 404 such as the first layer 320 of electrodes that are deposited on top of the color filter glass layer 325 of FIG. 3. A second set of electrodes (e.g., a set of electrodes that are oriented in a second direction such as a horizontal direction) may be the Tx electrodes 402 such as the second layer 342 of electrodes that are on top of the TFT glass layer 345 and/or within the TFT circuitry layer 340 of FIG. 3.

The processing system 110, including the touch controller 408 and DDIC 406 of FIG. 4, may be configured to provide display functionalities (e.g., displaying images and/or videos on a display device 160) and touch functionalities (e.g., sensing input objects on the sensing region 170 of the display device 160). For example, the processing system 110 may be configured to update a display screen or panel (e.g., the display screen of the display device 160 and/or 365). In addition, the processing system 110 may be configured to provide touch functionalities such as sensing an input object 140 on a sensing region 170. As mentioned previously, the display and touch functionalities may share a time budget (e.g., a time budget of a number of frames such as one hundred frames each cycle). As such, the more frames that are required for the touch functionality would result in fewer frames that are able for the display functionality. Therefore, examples of the present disclosure describe a multi-frequency sensing scheme for hybrid in-cell systems (e.g., the hybrid in-cell system / sensor that includes the first layer 320 and second layer 342 of electrodes positioned within the display cell 360), which may reduce the time budget for the touch functionality and thus increase the time budget allotment for the display functionality. This may further improve the performance of the display devices 160 and/or 365 due to the increased time budget allotment for the display functionality.

For example, in operation, the touch controller 408 (TCH / CPU) of FIG. 4 may drive the Tx electrodes 402 based on providing a drive signal (e.g., a drive voltage). The Rx electrodes 404 may obtain a resulting signal based on driving the Tx electrodes 402 using the drive signal. The resulting signal may be provided back to the touch controller 408, and may be used to detect a location of the input object (e.g., the input object 140 such as a user’s finger on the sensing region 170). For instance, each Rx electrode of the Rx electrodes 404 may provide a resulting signal back to the touch controller 408 via an Rx connection (e.g., a flexible printed circuit (FPC) 410) and the touch controller 408 may determine a sensing profile based on the resulting signals. In some examples, the touch controller 408 may be unable to perform the touch functionality (e.g., determine the location / position of the input object 140) based on driving the Tx electrodes 402 using the same frequency. For example, for multi-frequency sensing, the touch controller 408 may determine a region (e.g., a touch area such as the region 416) where the input object 140 interacts with the sensing region 170 based on a demodulation of each of the frequencies. However, if each region within the sensing region 170 is driven by the same frequency, the touch controller 408 may be unable to perform the demodulation process and therefore may be unable to determine the touch region that the input object 140 has interacted with.

As such, due to the input device 100 having an hybrid in-cell system (e.g., a hybrid in-cell sensor) that includes the Rx electrodes 404 being positioned on the color filter glass layer 325 and the Tx electrodes 402 being positioned on the TFT glass layer 345 and/or within the TFT circuitry layer 340, the touch controller 408 may be configured to drive different subsets of the Tx electrodes 402 using different frequencies (e.g., multiple frequencies). For example, as shown in FIG. 4, the Tx electrodes 402 are separated into three regions 412-416 and each region would include a subset of Tx electrodes (e.g., each subset would include three Tx electrodes). For instance, as mentioned above, FIG. 4 shows only three Tx electrodes 402 in the region 416 for clarity, but regions 412 and 414 may also include a number of Tx electrodes 402. The three regions 412-416 and the three Tx electrodes 402 within each of the three regions 412-416 are merely exemplary and the Tx electrodes 402 may be separated into any number of regions. Furthermore, each subset of Tx electrodes 402 may include any number of Tx electrodes such as two Tx electrodes, four Tx electrodes, and so on.

The touch controller 408 may drive each subset of Tx electrodes 402 (e.g., the Tx electrode within a particular region) using a different frequency. By the touching controller 408 driving each subset of the Tx electrodes 402 directly, this may result in a multi-frequency direct Tx electrode driving scheme 400. For instance, as shown, the first region 412 may be driven with a first frequency (“Freq0”), the second region 414 may be driven with a second frequency (“Freq1”), and the third region may be driven with a third frequency (“Freq2”). The Rx electrodes 404 may then obtain the resulting signals based on driving the Tx electrodes 402 using the multiple frequencies (e.g., the first through third frequencies), and then a location of the input object may be determined based on the sensing profile from the Rx electrodes 404.

As such, instead of driving each of the subsets of Tx electrodes 402 with the same frequency, which would require additional frames, the touch controller 408 for the hybrid in-cell system may drive each subset of Tx electrodes 402 using a different frequency within the same frame. For instance, rather than utilizing three separate frames to drive the three separate subsets of Tx electrodes 402, the touch controller 408 may use one frame to drive all three subsets of Tx electrodes 402 based on driving each of the subsets using a different frequency (e.g., three total frequencies). As such, the time budget for performing the driving scheme described by FIG. 4 would be reduced drastically from the time budget of conventional sensing techniques that utilize the system driven by conventional non-multi frequency sensing (e.g., from three frames to one frame based on using the multi-frequency direct Tx electrode driving scheme 400). Therefore, due to the reduced time budget for the driving functionality, additional time budget may be able to be allocated to the display functionality, which improves the performance of the display devices 160 and/or 365.

Furthermore, in some examples, additional Tx electrodes may also be added to the input device 100 based on utilizing the multi-frequency direct Tx electrode driving scheme 400 of FIG. 4. For instance, by maintaining the same touch time budget and/or by reducing the touch time budget by a small amount (e.g., less than a factor of three when using three frequencies), additional Tx electrodes may be included within the input device 100. For example, an input device 100 may include nine Tx electrodes that are driven using the same frequency, which may result in a first time budget (e.g., three frames). By using multiple frequencies, the same time budget (e.g., three frames) or a smaller time budget may continue to be utilized, but this may enable driving of additional Tx electrodes. For instance, by using three frequencies, twenty-seven Tx electrodes may be driven with the first time budget (e.g., a first frame that drives nine Tx electrodes, a second frame that drives nine Tx electrodes, and a third frame that drives nine Tx electrodes). As such, additional Tx electrodes may be included within the input device 100 based on utilizing the multi-frequency direct Tx electrode driving scheme 400.

Additionally, and/or alternatively, lower power consumption may be utilized. For example, even with the same panel size (e.g., nine Tx electrodes), the input device 100 may reduce the power consumption based on using the multi-frequency direct Tx electrode driving scheme 400. For instance, for multi-frequency sensing, the time budget for touch sensing may be reduced (e.g., by a factor of three based on using three frequencies). When the time budget is reduced, the touch period may be also reduced and the non-touch period may be increased accordingly. The touch controller 408 may be in the idle mode during the non-touch period (e.g., during the period for performing the display functionality), which thus leads to lower power consumption.

Furthermore, as shown, the DDIC may provide a Vsync to the touch controller 408. While three frequencies are shown in FIG. 4, the processing system 110 may utilize any number of frequencies to drive any number of Tx electrodes 402 within the input device 100.

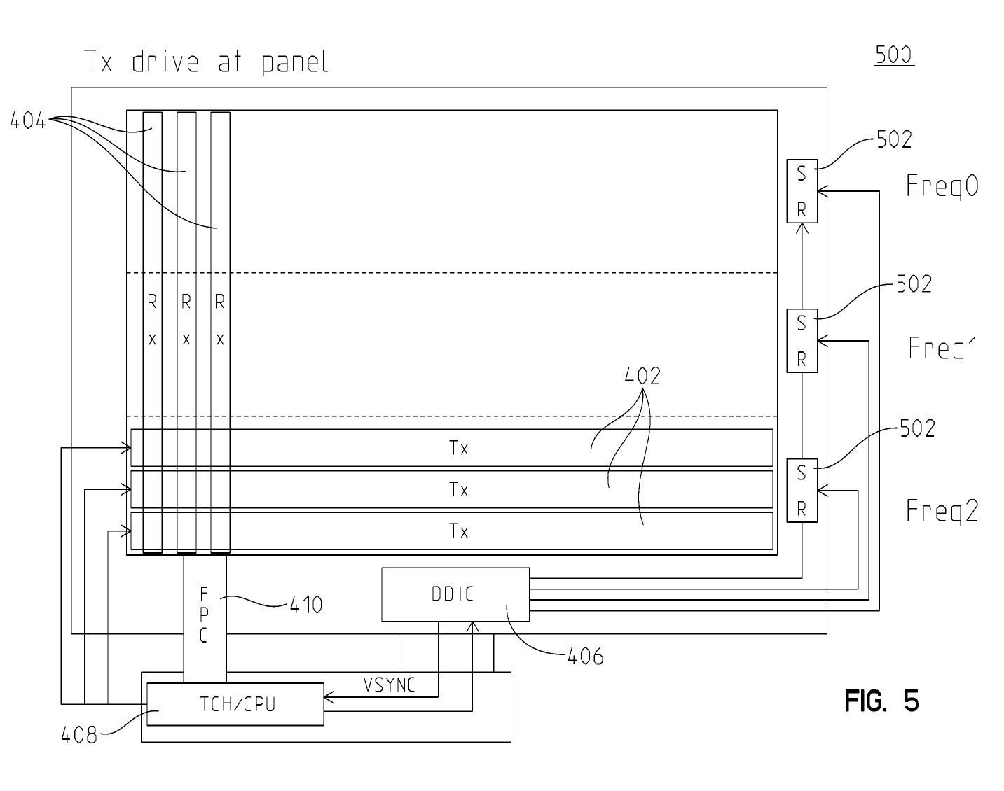

FIG. 5 illustrates an exemplary multi-frequency transmitter electrode driving scheme 500 at the display panel according to one or more examples of the present disclosure. For instance, instead of the touch controller 408 driving the Tx electrodes 402, in the multi-frequency transmitter electrode driving scheme 500, the DDIC 406 may drive the Tx electrodes 402. For example, the touch controller 408 and the DDIC 406 may communicate with each other such as by providing Vsync signals and/or other information. Furthermore, the DDIC 406 may drive the Tx electrodes 402 at different frequencies. For instance, similar to FIG. 4, the Tx electrodes 402 may be separated into different regions 412-416 / subsets, and may be driven by the DDIC 406. For instance, the DDIC 406 may drive a first subset of Tx electrodes 402 using a first frequency (“Freq0”), a second subset of Tx electrodes 402 using a second frequency (“Freq1”), and a third subset of Tx electrodes 402 using a third frequency (“Freq3”).

In addition, for the multi-frequency transmitter electrode driving scheme 500, the input device 100 may further include one or more shift registers (SR) 502. For example, the shift registers 502 may be configured to drive the Tx electrodes 402 within each subset sequentially. For instance, based on the input device 100 including nine Tx electrodes 402 that are separated into three subsets, the DDIC 406 may use the shift registers 502 to drive the three subsets of Tx electrodes 402 using different frequencies. For example, in a first frame, the DDIC 406 may drive a first Tx electrode from each of the three subsets of Tx electrodes 402 using the three different frequencies (e.g., a first Tx electrode from the first subset may be driven using a first frequency, a first Tx electrode from the second subset using a second frequency, and a first Tx electrode from the third subset using a third frequency). Then, in a second frame, the DDIC 406 may drive a second Tx electrode from each of the three subsets of Tx electrodes 402 using the three different frequencies (e.g., a second Tx electrode from the first subset may be driven using a first frequency, a second Tx electrode from the second subset using a second frequency, and a second Tx electrode from the third subset using a third frequency). In the third frame, the DDIC 406 may drive a third Tx electrode from each of the three subsets of Tx electrodes 402 using the three different frequencies.

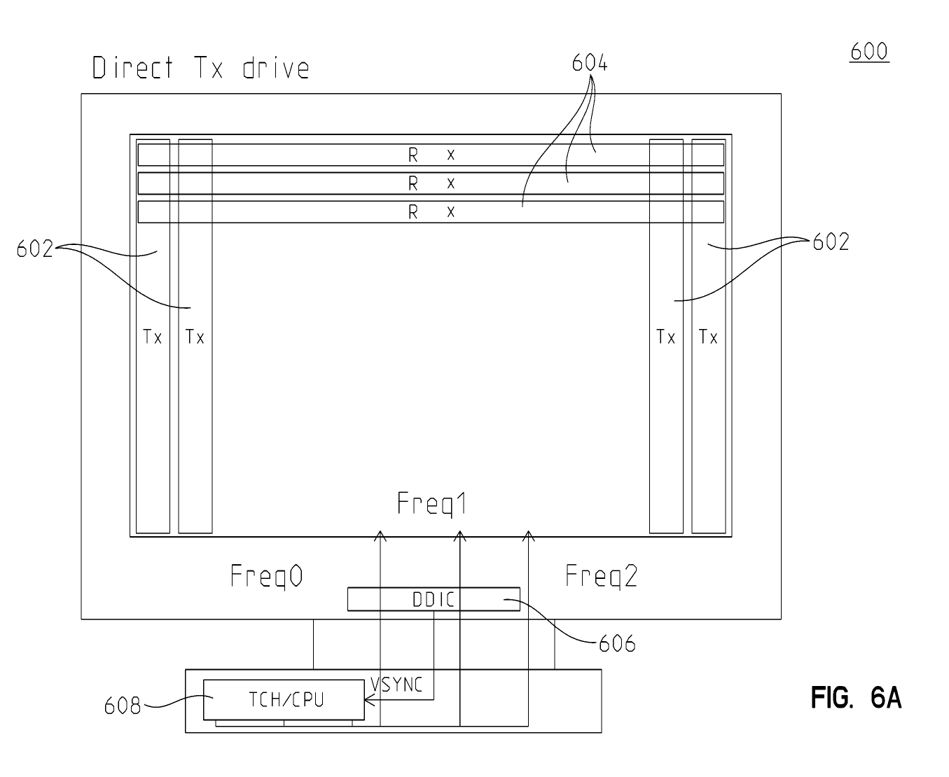

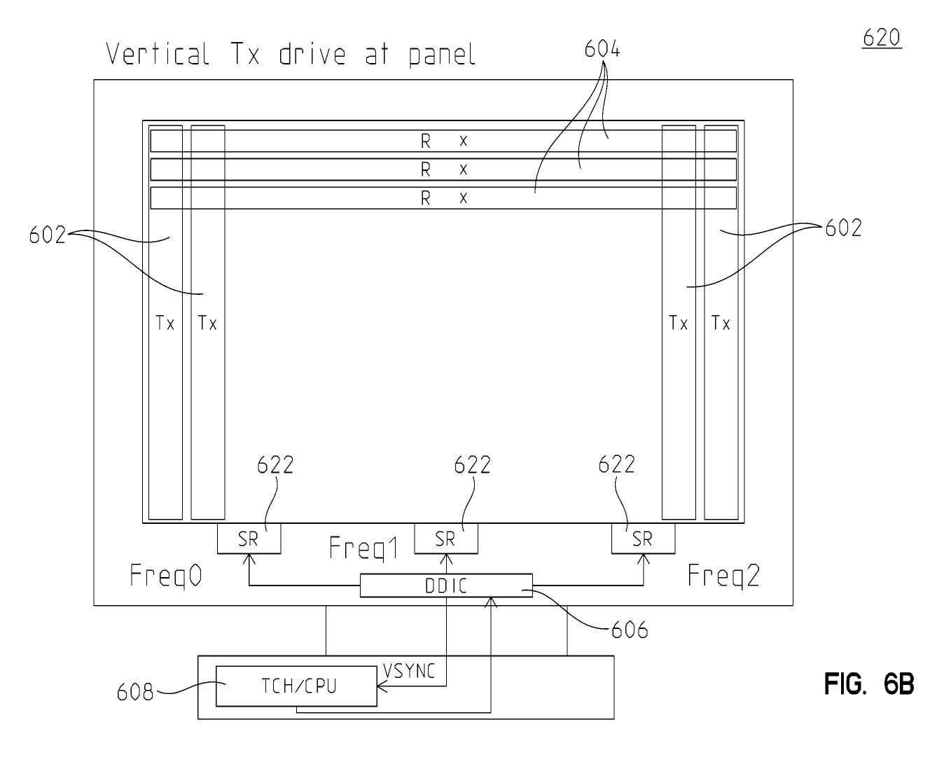

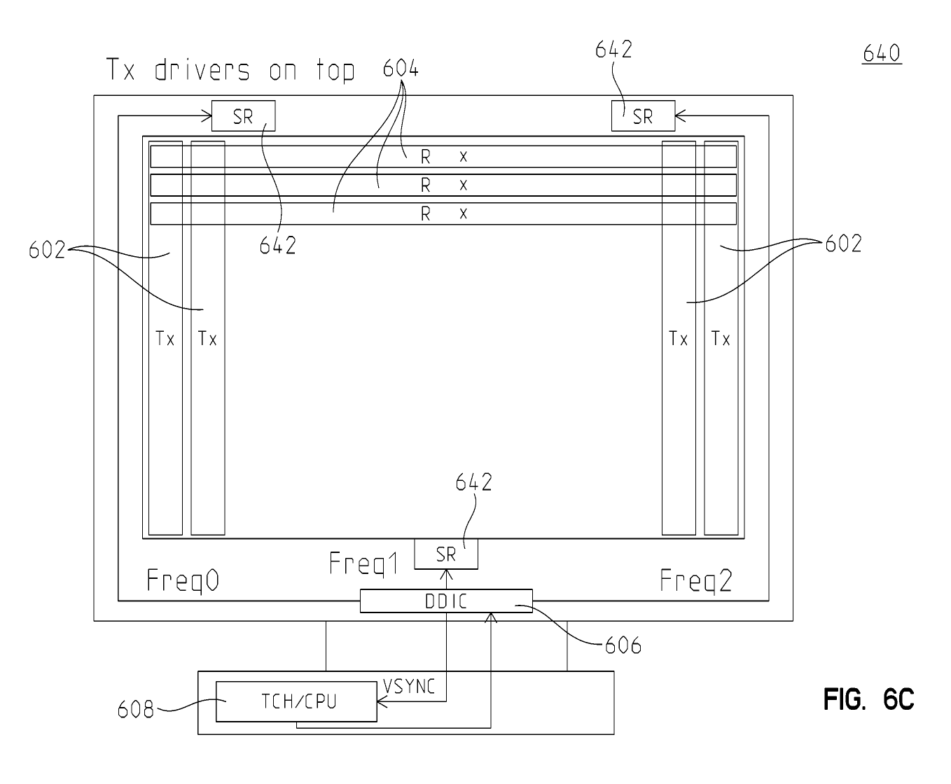

FIGS. 6A-6C illustrate exemplary multi-frequency vertical transmitter electrode driving schemes 600, 620, and 640, respectively, according to one or more examples of the present disclosure. For example, FIGS. 6A-6C describe similar driving schemes to FIGS. 4 and 5 except that instead of the Tx electrodes being horizontal electrodes, in FIGS. 6A-6C, the Tx electrodes 602 are vertical electrodes. As such, due to the Tx electrodes 602 being vertical electrodes, then the Rx electrodes 604 are horizontal electrodes.

For instance, referring to FIG. 6A, the multi-frequency vertical transmitter electrode driving scheme 600 may drive the Tx electrodes 602 that are oriented in a vertical direction. For example, referring to FIG. 6A, similar to the multi-frequency direct transmitter electrode driving scheme 400, the multi-frequency vertical transmitter electrode driving scheme 600 may use the touch controller 608 to drive the Tx electrodes 602 using multiple frequencies (e.g., three frequencies). For example, the vertical Tx electrodes 602 may be separated into three subsets and the touch controller 608 may drive each of the subsets using a different frequency. In addition, only four Tx electrodes 602 and only three Rx electrodes 604 are shown in FIGS. 6A-6C for clarity, but there may be any number of Tx electrodes 602 and Rx electrodes 604 including Tx electrodes 602 and Rx electrodes 604 that span the entire length and width of the input device 100.

Referring to FIG. 6B, similar to the multi-frequency transmitter electrode driving scheme 500 at the display panel, the multi-frequency vertical transmitter electrode driving scheme 620 may use the DDIC 606 to drive the Tx electrodes 602 using multiple frequencies. For example, the vertical Tx electrodes 602 may be separated into three subsets and the DDIC 606 may drive each of the subsets using a different frequency. In addition, to driving the three subsets, the input device 100 may further include shift registers (SR) 622. The shift registers 622 may be positioned in a first portion of the input device 100. For example, the vertical Tx electrodes 602 may include a first end and a second end (e.g., the first end may be on top of the input device 100 and the second end may be on the bottom of the input device 100). In other words, the input device 100 may be a television, and the first end may be the top of the television and the second end may be on the bottom of the television (e.g., closer to ground). In FIG. 6B, the shift registers 622 may be electrically connected (e.g., wired) to the second end of the vertical Tx electrodes 602 (e.g., on the bottom of the television that is closer to ground).

Referring to FIG. 6C, similar to the multi-frequency transmitter electrode driving scheme 500 at the display panel and the multi-frequency vertical transmitter electrode driving scheme 620, the multi-frequency vertical transmitter electrode driving scheme 640 may use the DDIC 606 to drive the Tx electrodes 602 using multiple frequencies. However, as shown in FIG. 6C, the shift registers 642 may be placed on different ends of the vertical Tx electrodes 602. For example, a first number of shift registers (e.g., two shift registers) of the shift registers 642 may be connected to a first end of the Tx electrodes 602 and a second number of shift registers of the shift registers 642 (e.g., one shift register) may be connected to a second end of the Tx electrodes 602. For example, the Tx electrodes 602 may be separated into three subsets. The first and third subsets of Tx electrodes may be electrically connected to the shift registers 642 at the top of the input device 100 and the second subset of Tx electrodes may be electrically connected to the shift register 642 at the bottom of the input device 100. In other words, the first end of the vertical Tx electrodes of the first and third subset may be electrically connected to the shift registers 642 and the second end of the vertical Tx electrodes of the second subset may be electrically connected to the shift register 642.

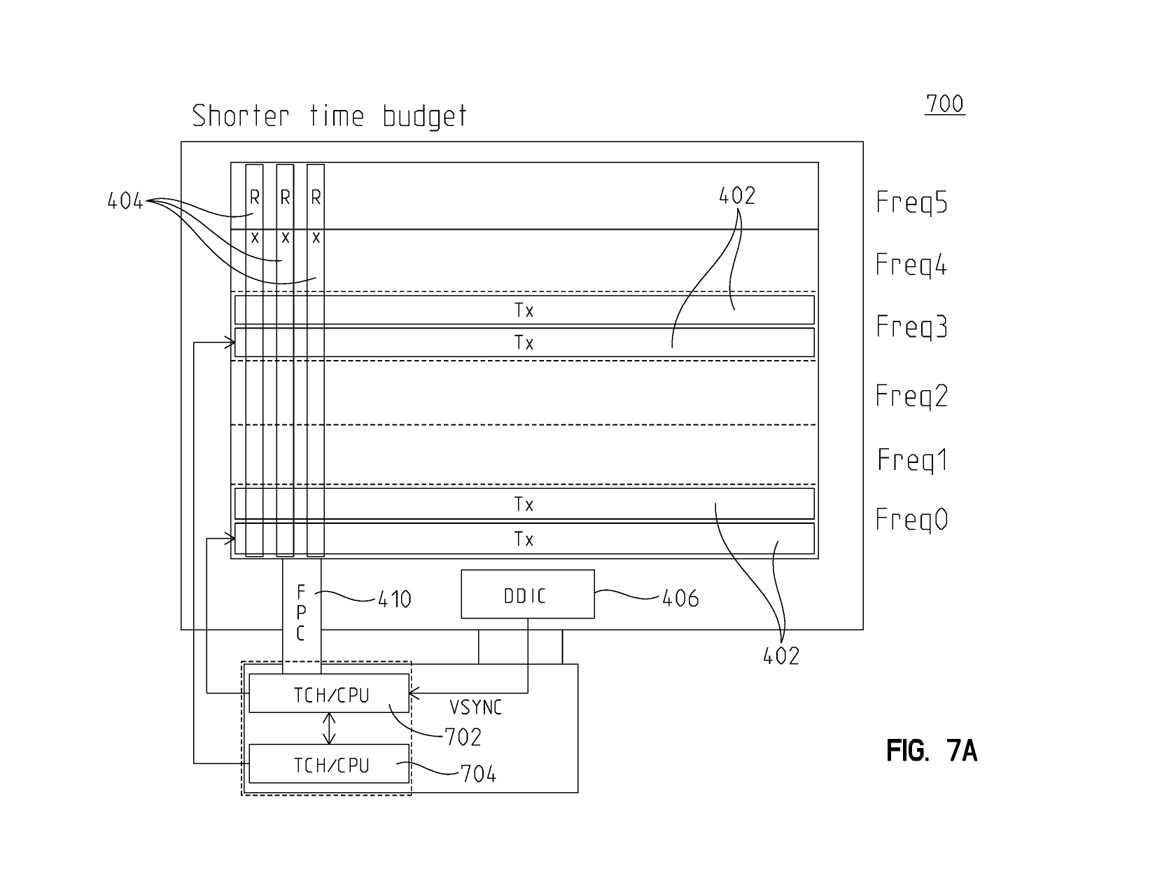

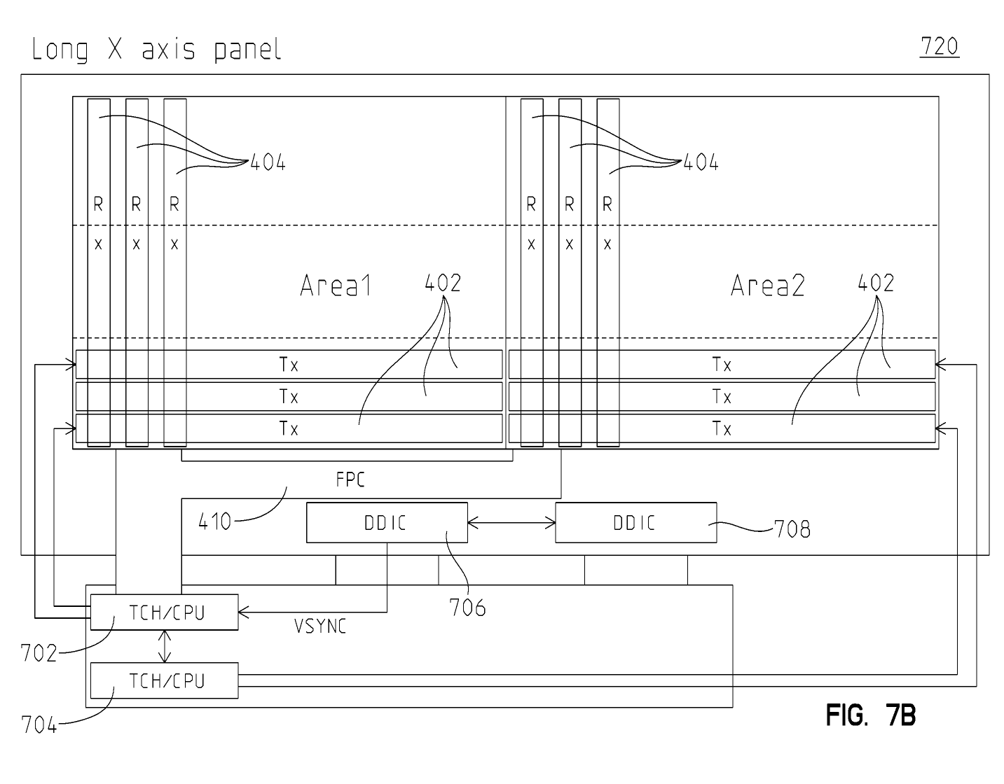

FIGS. 7A-7B illustrate additional multi-frequency transmitter electrode driving schemes 700 and 720, respectively, according to one or more examples of the present disclosure.

For instance, referring to FIG. 7A, the multi-frequency transmitter electrode driving scheme 700 may be similar to the multi-frequency direct transmitter electrode driving scheme 400 except that more than three frequencies are used to drive the Tx electrodes 402. For example, instead of using three frequencies and as mentioned above, additional frequencies (e.g., the six frequencies are used, which further includes “Freq3”, “Freq4”, and “Freq5”). For instance, instead of separating the Tx electrodes 402 into three subsets, in FIG. 7A, the Tx electrodes 402 are separated into six subsets. Furthermore, instead of having one touch controller 408, which is shown in FIG. 4, the input device 100 for the multi-frequency transmitter electrode driving schemes 700 may include two touch controllers 702 and 704. The first touch controller 702 may be configured to drive three subsets of Tx electrodes 402 and the second touch controller 704 may be configured to drive the other three subsets of Tx electrodes 402. While two touch controllers 702-704 are shown, in some examples, a single touch controller or more than two touch controllers may be used to drive the six subsets of Tx electrodes 402. Furthermore, while six frequencies and six subsets of Tx electrodes 402 are shown, in other examples, a different number of frequencies and/or subsets of Tx electrodes 402, including the number of Tx electrodes 402 within each subset, may be used.

In some examples, instead of having two touch controllers 702-704 drive the Tx electrodes 402, the DDIC 406 (and/or multiple DDICs) may be used to drive the Tx electrodes 402, which is described above in FIG. 5. In some variations, instead of the horizontal Tx electrodes 402, the multi-frequency transmitter electrode driving scheme 700 may be applied to vertical Tx electrodes, which is described in FIGS. 6A-6C.

Referring to FIG. 7B, the multi-frequency transmitter electrode driving scheme 720 may be similar to the multi-frequency direct transmitter electrode driving scheme 400 except that there may be additional regions and subsets that are driven with different frequencies. For example, as shown, an input device may have a larger display screen such that two Tx electrodes of the Tx electrodes 402 would be included in each row. To put it another way, for the sensor arrangement shown in FIG. 7B, the input device 100 may include a plurality of rows of horizontal Tx electrodes 402, and each row may include two Tx electrodes. As such, the input device 100 may include two columns of Tx electrodes 402, with each column driven by a respective touch controller 702 or 704 (e.g., the TCH/CPU). Each row including two Tx electrodes is merely exemplary and additional Tx electrodes may be included within each row. Furthermore, two columns of Tx electrodes are merely exemplary and more than two columns of Tx electrodes may be included. The Rx electrodes 404 may be similar to the Rx electrodes described above in FIG. 4, which span the entire length of the input device 100.

In operation, the Tx electrodes 402 may be separated into subsets of Tx electrodes. For example, a first column of Tx electrodes 402 may be separated into three subsets (e.g., a first, second, and third subset) and a second column of Tx electrodes 402 may be separated into three additional subsets (e.g., a fourth, fifth, and sixth subset). The touch controllers 702-704 may be configured to drive the subsets of Tx electrodes 402 using different frequencies (e.g., using six frequencies), which is described above. In some instances, two touch controllers b-704 are used for the multi-frequency transmitter electrode driving schemes 720. The first touch controller 702 may be configured to drive the first column of Tx electrodes 402 and the second touch controller 704 may be configured to drive the second column of Tx electrodes 402. In other instances, a single touch controller or more than two touch controllers may be configured to drive the Tx electrodes. In yet other instances, the DDIC or multiple DDICs may be configured to drive the Tx electrodes 402, which is described above. For example, two DDICs 706-708 are shown in FIG. 7B.

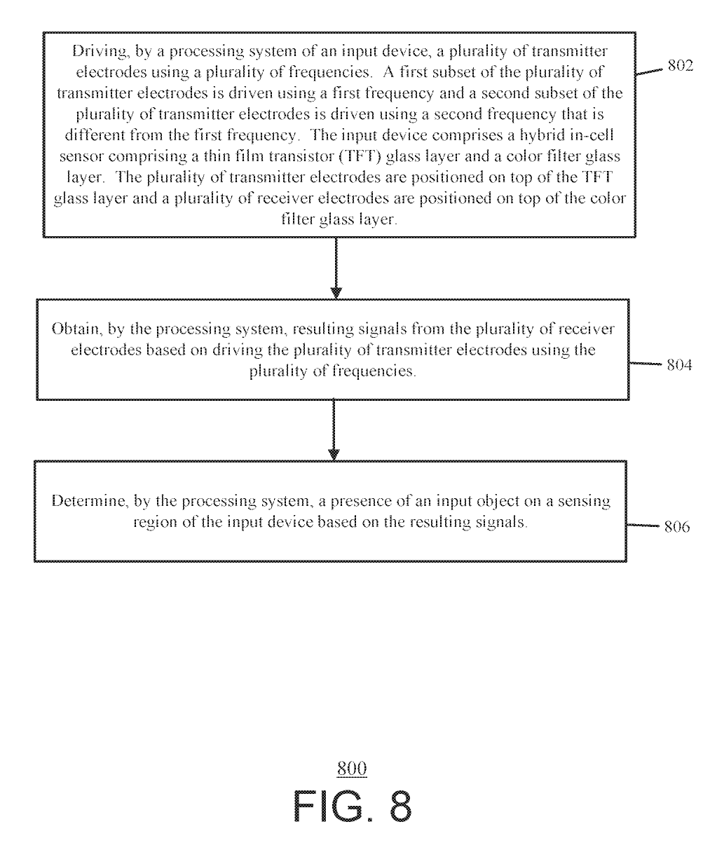

FIG. 8 depicts an exemplary flowchart performing a multi-frequency transmitter electrode driving scheme according to one or more examples of the present disclosure. The process 800 may be performed by the input device 100 and, in particular, the processing system 110 shown in FIG. 1. However, it will be recognized that an input device that includes additional and/or fewer components as shown in FIG. 1 may be used to perform process 800, that any of the following blocks may be performed in any suitable order, and that the process 800 may be performed in any suitable environment. The descriptions, illustrations, and processes of FIG. 8 are merely exemplary and the process 800 may use other descriptions, illustrations, and processes for performing the multi-frequency transmitter electrode driving scheme.

For example, at block 802, the processing system 110 of the input device 100 may drive a plurality of Tx electrodes using a plurality of frequencies. A first subset of the plurality of Tx electrodes is driven using a first frequency and a second subset of the plurality of Tx electrodes is driven using a second frequency that is different from the first frequency. The input device comprises a hybrid in-cell sensor comprising a TFT glass layer 345 and a color filter glass layer 325. The plurality of Tx electrodes are positioned on top of the TFT glass layer 345 (e.g., a first side of the TFT glass layer 345) and a plurality of Rx electrodes are positioned on top of the color filter glass layer 325 (e.g., a first side of the color filter glass layer 325). For example, the processing system 110 may use the driving schemes described in FIGS. 4, 5, 6A-6C and/or 7A-7C to drive the plurality of Tx electrodes of the input device 100 that includes the hybrid in-cell system (e.g., the hybrid in-cell system described by FIG. 3).

At block 804, the processing system 110 may obtain resulting signals from the plurality of receiver electrodes based on driving the plurality of transmitter electrodes using the plurality of frequencies. At block 806, the processing system 110 may determine a presence of an input object on a sensing region of the input device based on the resulting signals.

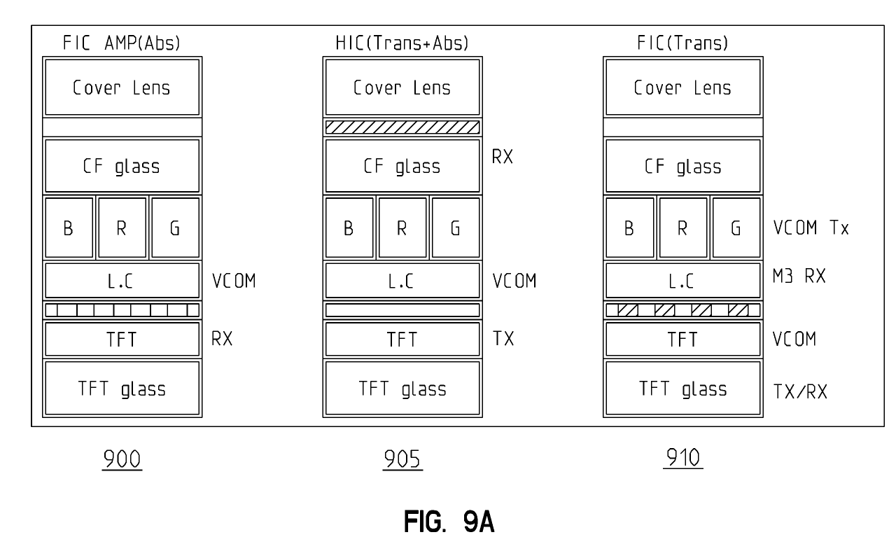

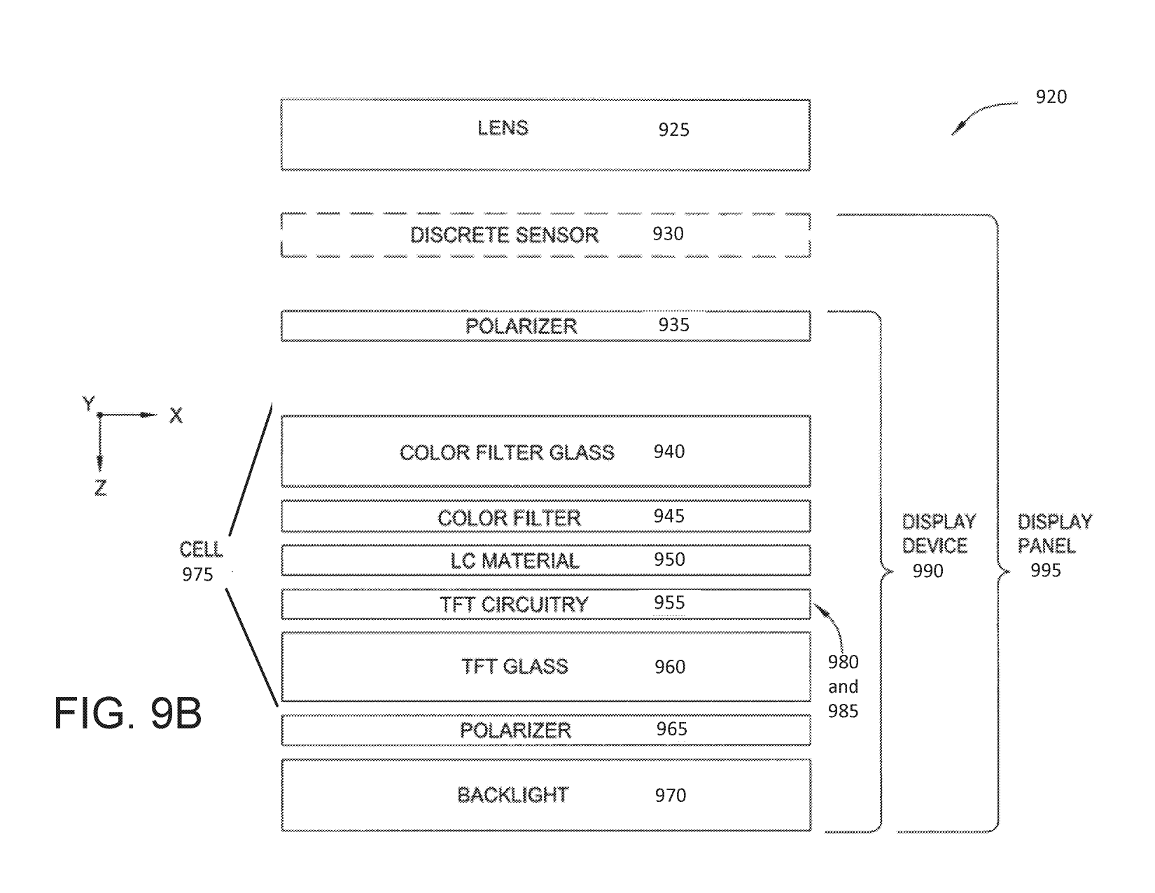

The above describes a hybrid in-cell system that includes Rx electrodes positioned on top of the color filter glass layer 325 and Tx electrodes positioned on top of the TFT glass layer 345 (e.g., deposited on top of the TFT glass layer 345 and/or included within the TFT circuitry layer 340). The hybrid-in cell system may utilize multi-frequency sensing schemes to achieve numerous advantages such as reducing the touch time budget and/or providing improved display performance. In other instances, the multi-frequency sensing scheme may be utilized in full in-cell systems. For example, as mentioned above, full-AMP in-cell systems may include electrodes that share the Vcom layer (e.g., the layer comprising the TFT circuitry 340) and use an absolute touch sensing scheme. However, the absolute touch sensing scheme cannot utilize nor support multi-frequency sensing. In contrast, the below describes a variation of the full-AMP in-cell system that allows for multi-frequency sensing. For instance, the full in-cell system described below includes the Tx electrodes and the Rx electrodes positioned on top of the TFT glass layer. The full-AMP in-cell system, the hybrid in-cell system, and the full in-cell system that allows for multi-frequency system are shown and described in FIG. 9A.

FIG. 9A illustrates exemplary sensor electrode arrangements according to one or more examples of the present disclosure. For instance, FIG. 9A shows three sensor electrode arrangements 900, 905, and 910. The sensor electrode arrangement 900 may be a sensor electrode arrangement for the full-AMP in-cell system. For instance, the full-in cell (FIC) AMP sensor electrode arrangement 900 may be configured to perform an absolute touch sensing scheme but might not be capable of performing a transcapacitive sensing scheme. For example, as shown, the receiver (Rx) electrodes may be included within the Vcom layer, but the sensor electrode arrangement 900 might not include Tx electrodes. Without the Tx electrodes (e.g., without the Tx electrodes oriented in a perpendicular direction from the Rx electrodes), the full-in cell (FIC) AMP sensor electrode arrangement 900 is unable to perform a transcapacitive sensing scheme and instead performs an absolute touch sensing scheme. Thus, to reduce time budgets, the FIC AMP sensor electrode arrangement 900 may need more AFEs, which impacts ASIC costs and also impacts the power consumption as well.

In contrast, the hybrid in-cell (HIC) sensor electrode arrangement 905 includes the Rx electrodes above the color filter glass layer (e.g., the color filter glass layer 345) and the Tx electrodes within the Vcom layer (e.g., above the TFT glass layer). This allows the HIC sensor electrode arrangement 905 to perform a transcapacitive sensing scheme, which further allows for multi-frequency sensing. However, because the Rx electrodes are above the color filter glass layer, Rx wirings from the color filter glass layer are used to connect the Rx electrodes (e.g., patterned Rx electrodes) to the other sensing elements. The HIC sensor electrode arrangement 905 is described in further detail in FIG. 3 above and the multi-frequency sensing for the HIC sensor electrode arrangement 905 is described in further detail in FIGS. 4-8.

In addition, the FIC sensor electrode arrangement 910 is also capable of performing a transcapacitive sensing scheme and thus is capable of performing multi-frequency sensing. For instance, the FIC sensor electrode arrangement 910 shows a full in-cell system where both the Rx electrodes and the Tx electrodes are included within the TFT circuitry (e.g., within the Vcom layer and/or the M3 layer). In some examples, the FIC sensor electrode arrangement 910 may be within an LCD panel and the Tx and Rx electrodes may all be on the TFT glass (e.g., positioned above the TFT glass). By utilizing the FIC sensor electrode arrangement 910, this may provide advantages such as improving touch performance and/or display performance as well as reducing the system cost. For instance, by utilizing the FIC sensor electrode arrangement 910, multi-frequency sensing may be achieved without Rx wirings connecting to the color filter glass layer (e.g., the color filter glass layer 345). In other words, in the HIC sensor electrode arrangement 905, the Rx electrodes are above the color filter glass layer and thus Rx wirings that connect to the color filter glass layer are used. In contrast, by using the FIC sensor electrode arrangement 910 and including the Rx electrodes within the cell, multi-frequency sensing may be achieved without Rx wirings connecting to the color filter glass layer. Additionally, and/or alternatively, patterned Rx electrodes on the color filter glass layer might not be necessary, which may provide a further benefit for full in-cell systems as compared to hybrid in-cell systems. FIG. 9B describes the FIC sensor electrode arrangement 910 in more detail.

FIG. 9B illustrates an exemplary full in-cell system that includes transmitter and receiver electrodes within a TFT circuitry layer according to one or more examples of the present disclosure. For example, FIG. 9B may show an exemplary multiple-layer arrangement of a full in-cell system (e.g., an input device 100 having a full in-cell sensor) that is capable of performing a transcapacitive sensing scheme. FIG. 9B may include many similar components and/or elements to FIG. 3 above and may show a cross-sectional view of an input device 920 comprising a display device 990. Note that the various layers depicted within the input device 920 are not drawn to scale, and the layers may be laminated together or otherwise connected within the input device 920. The depicted input device 920 is meant as one non-limiting example, as suitable alternate arrangements of the input device 920 can include more or less layers, may arrange the layers with a different order, etc.

The input device 920 may be substantially similar to the input device 300 of FIG. 3 except that the location of the first layer of sensor electrodes may be different. For instance, similar to the input device 300, the input device 920 includes a display panel 995 and a display device 990. The input device 920 further includes a lens layer 925, a discrete sensor layer 930, a polarizer layer 935, a color filter glass layer 940, a color filter layer 945, a liquid crystal (LC) material layer 950, a thin-film transistor (TFT) circuitry layer 955, a TFT glass layer 960, a polarizer layer 965, and a backlight layer 970.

The input device 920 also includes a first layer 980 of sensor electrodes (e.g., a first subset of the sensor electrodes 120) and a second layer 985 of sensor electrodes (e.g., a second subset of the sensor electrodes 120). However, in contrast to the hybrid in-cell sensor arrangement shown in FIG. 3, the first layer 980 of sensor electrodes are not disposed between the color filter glass layer 940 and the polarizer layer 935. For instance, as shown, both the first layer 980 of sensor electrodes and the second layer 985 of sensor electrodes are disposed above the TFT glass layer 960 (e.g., deposited above the TFT glass layer 960 and/or within the TFT circuitry layer 955). In some instances, the first layer 980 of sensor electrodes may be the Rx electrodes and the second layer 985 of sensor electrodes may be the Tx electrodes.

In some variations, the TFT circuitry layer 955 comprises a plurality of common (Vcom) electrodes of the display device 990. In some embodiments, and as shown, a display cell 975 (e.g., a full in-cell) is defined between color filter glass layer 940 and TFT glass layer 960. The first layer bof sensor electrodes and the second layer 985 of sensor electrodes are disposed within the display cell 975.

In some examples, the TFT circuitry layer 955 may include the Rx and the Tx electrodes that are used for the touch functionality and may further include Vcom electrodes that are used for the display functionality. In some instances, the touch functionality and the display functionality may use the same electrodes. In other words, the first layer 980 of sensor electrodes may include the Rx electrodes as well as the Vcom electrodes and/or the second layer 985 of sensor electrodes may include the Tx electrodes as well as the Vcom electrodes. For instance, for the full in-cell system shown in FIG. 9B, the same electrode (e.g., the same electrode from the first layer 980 or the second layer 985) may be used for touch and display functionality based on utilizing a time divided system. For example, the electrode may operate as a touch Tx electrode (or Rx electrode) during the touch period (e.g., a time period allocated for the touch functionality) and may operate as a display Vcom electrode during the display period (e.g., a time period allocated for the display functionality).

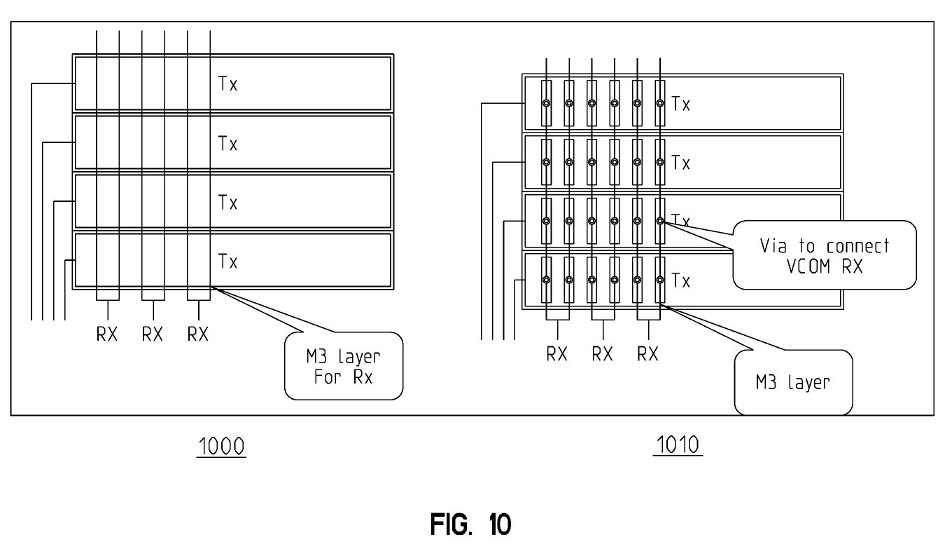

Exemplary arrangements of the Rx electrodes and the Tx electrodes within the TFT circuitry layer 955 are shown in further detail in FIG. 10. FIG. 10 illustrates exemplary architectures 1000 and 1010 of the full in-cell system that includes transmitter and receiver electrodes within the TFT circuitry layer 955 according to one or more examples of the present disclosure. For instance, referring to the architecture 1000, the Tx electrodes and the Rx electrodes are bar electrodes that are positioned perpendicular to each other. For instance, the Tx electrodes are positioned in a first direction (e.g., the horizontal direction) and the Rx electrodes are positioned in a second direction (e.g., the vertical direction). As such, whereas in FIG. 3 the Tx electrodes are positioned above the TFT glass layer 345 but the Rx electrodes are positioned outside of the display cell 360 (e.g., above the color filter glass layer 325), in the architecture 1000, both the Tx electrodes and the Rx electrodes are positioned within the display cell 975 (e.g., deposited on top of the TFT glass layer 960 and/or within the TFT circuitry layer 955). Thus, in architecture 1000, the Rx electrodes may be associated with the M3 layer (e.g., the Rx electrodes may be included within the TFT circuitry layer 955) and might not be above the color filter glass layer 325. In addition, the full in-cell system (e.g., the sensor electrode arrangement 910) that uses the architecture 1000 may be a more cost-effective solution to the other sensor electrode arrangements described above because: 1) it might not include an additional layer and/or process as compared to the FIC AMP (e.g., the sensor electrode arrangement 900) and 2) it might not include a flexible printed circuit (FPC) and patterned Rx sensors on the color filter glass layer 940 as compared to the hybrid in-cell system (e.g., the sensor electrode arrangement 905).

The architecture 1010 may also show the Tx electrodes and the Rx electrodes being positioned within the display cell 975. For example, vias may be used to connect the Vcom Rx electrodes to the Tx electrodes within the M3 layer. For instance, ITO may be used for the Rx electrodes on the Vcom layer. The architecture 1010 may achieve similar benefits to the architecture 1000 (e.g., the architecture 1010 may be a cost-effective solution as compared to the FIC AMP and/or the hybrid in-cell system).

Based on using the input device 920 and/or architecture described in FIGS. 9B and 10, the processing system 110 may be configured to perform one or more multi-frequency sensing schemes. By using the input device 920 to perform the multi-frequency sensing schemes and similar to the hybrid in-cell system performing the multi-frequency sensing schemes, numerous technical advantages may be achieved including, but not limited to, reducing the touch time budget (e.g., by a factor of three or six based on the mixer numbers). For instance, as described above, the input device 920 may have a time sharing mechanism between the display and touch functionality, and thus reducing the touch time budget may provide for better display performance. Additionally, and/or alternatively, the usage of the multi-frequency sensing for full in-cell systems may further facilitate supporting of a much larger (e.g., increased width and height dimensions that include additional sensor electrodes) touch screen and/or allow for lower power consumption as well.

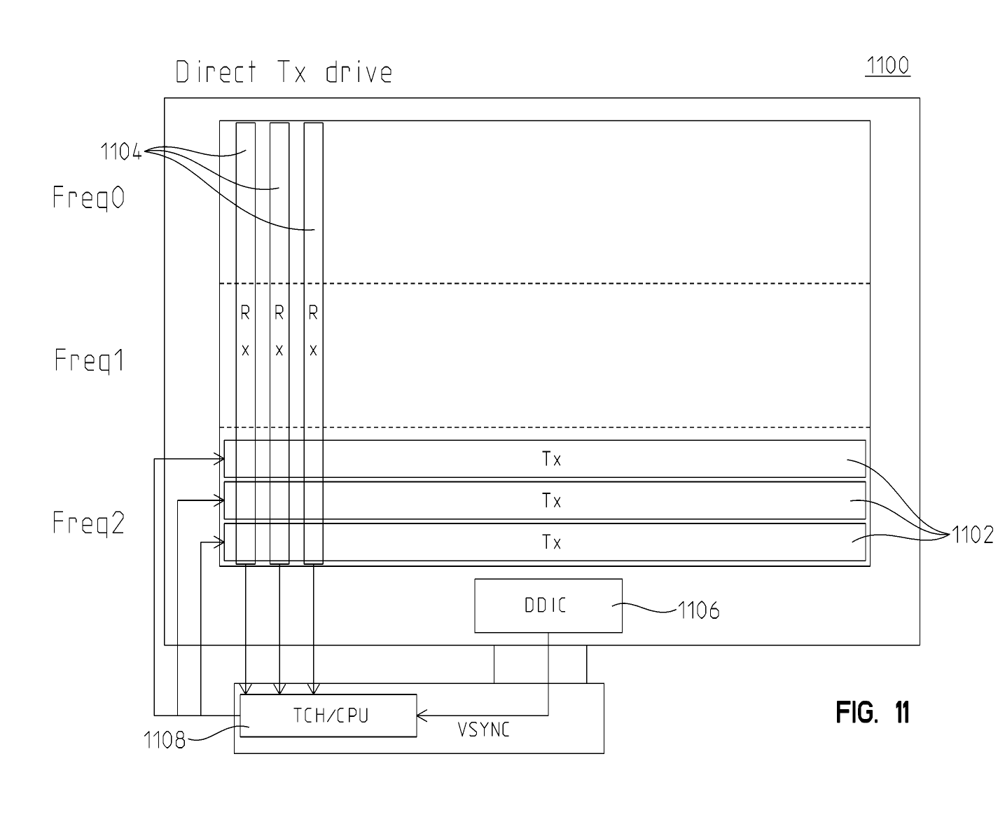

In some examples, based on utilizing the full in-cell system and/or architecture described in FIGS. 9B and 10, the processing system 110 of FIG. 1 may be able to use one or more multi-frequency sensing schemes. The multi-frequency sensing schemes are described in FIGS. 11-13B. As will be described in FIGS. 11-13B, the first layer 980 of sensor electrodes may be the Rx electrodes and the second layer 985 of sensor electrodes may be the Tx electrodes. In addition, the processing system 110 may include a sensor circuitry, which may be a touch controller and/or processor (e.g., a touch (TCH) / central processing unit (CPU) that is shown in FIGS. 11-13B). The processing system 110 may further include display driver circuitry, which may be a display driver integrated circuit (DDIC) that is shown in FIGS. 11-13B.

FIG. 11 illustrates an exemplary multi-frequency direct transmitter electrode driving scheme 1100 using the full in-cell system according to one or more examples of the present disclosure. For instance, the multi-frequency direct transmitter electrode driving scheme 1100 may be similar to the multi-frequency direct Tx electrode driving scheme 400 of FIG. 4 except that because the Rx electrodes 1104 are within the display cell 975, a FPC (e.g., the FPC 410) might not be needed. For instance, because the Rx electrodes 1104 are within the TFT circuitry layer 955, actual wire lines may be used to connect the Rx electrodes 1104 to the touch controller 1108 (e.g., the TCH/CPU). Otherwise, the multi-frequency direct transmitter electrode driving scheme 1100 may function similarly to the multi-frequency direct Tx electrode driving scheme 400.

For example, in operation, the touch controller 1108 (TCH / CPU) of FIG. 11 may drive the Tx electrodes 1102 based on providing a drive signal (e.g., a drive voltage). The Rx electrodes 1104 may obtain a resulting signal based on driving the Tx electrodes 1102 using the drive signal. The resulting signal may be provided back to the touch controller 1108, and may be used to detect a location of the input object. In addition, similar to FIG. 4, the touch controller 1108 may be configured to drive different subsets of the Tx electrodes 1102 using different frequencies (e.g., multiple frequencies). For example, as shown in FIG. 11, the Tx electrodes 1102 are separated into three regions and each region may include a subset of Tx electrodes 1102 (e.g., each subset would include three Tx electrodes). The three regions and the three Tx electrodes 1102 within each of the three regions are merely exemplary and the Tx electrodes 1102 may be separated into any number of regions. Furthermore, each subset of Tx electrodes 1102 may include any number of Tx electrodes such as two Tx electrodes, four Tx electrodes, and so on.

The touch controller 1108 may drive each subset of Tx electrodes 1102 using a different frequency. By the touching controller 1108 driving each subset of the Tx electrodes 1102 directly, this may result in a multi-frequency direct Tx electrode driving scheme 1100. For instance, as shown, the first region may be driven with a first frequency (“Freq0”), the second region may be driven with a second frequency (“Freq1”), and the third region may be driven with a third frequency (“Freq2”). The Rx electrodes 1104 may then obtain the resulting signals based on driving the Tx electrodes 1102 using the multiple frequencies (e.g., the first through third frequencies), and then a location of the input object may be determined based on the sensing profile from the Rx electrodes 1104.

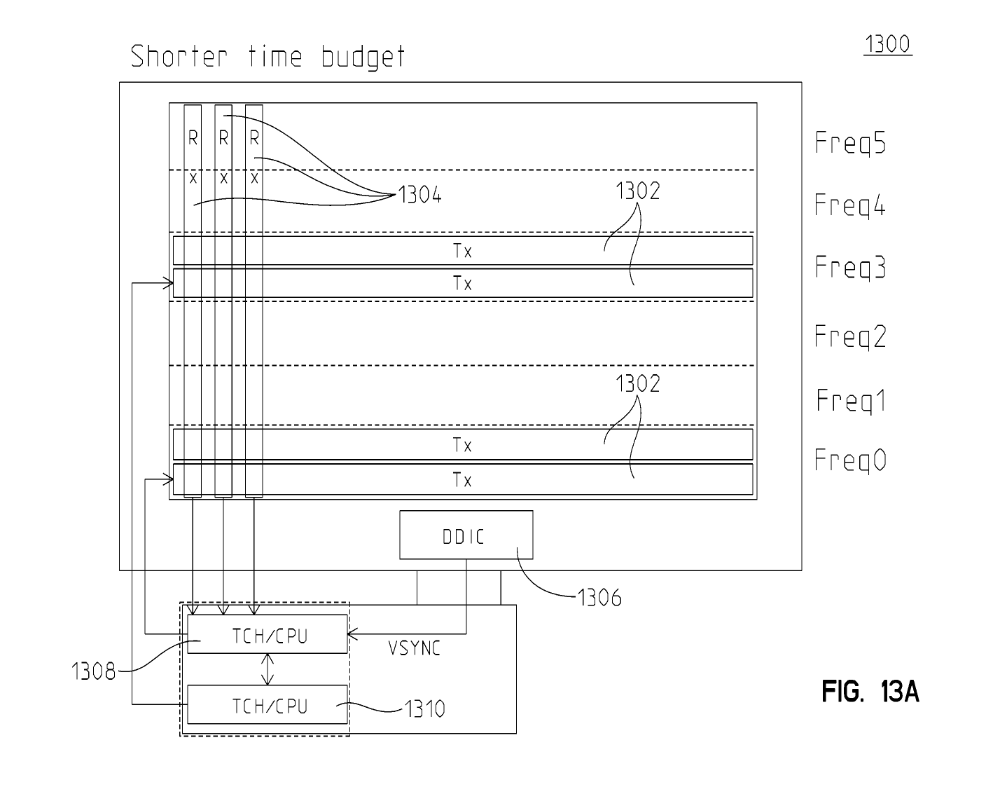

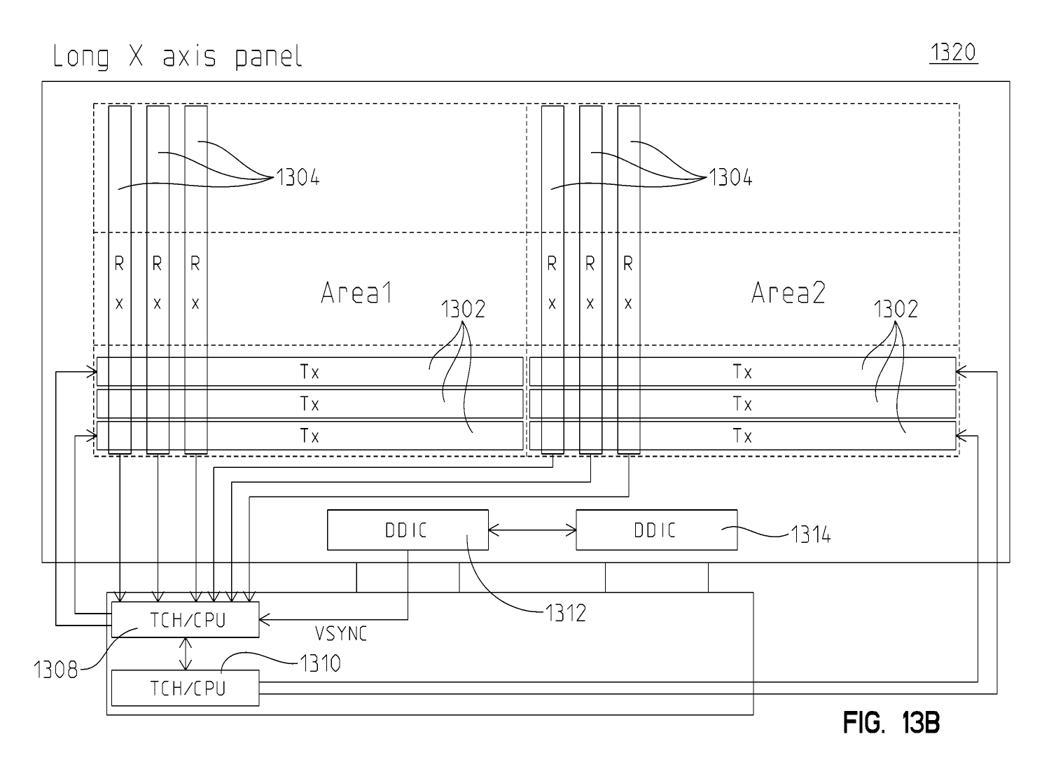

Furthermore, as shown, the DDIC 1106 may provide a Vsync to the touch controller 1108. While three frequencies are shown in FIG. 13, the processing system 110 may utilize any number of frequencies to drive any number of Tx electrodes 1102 within the input device 100.

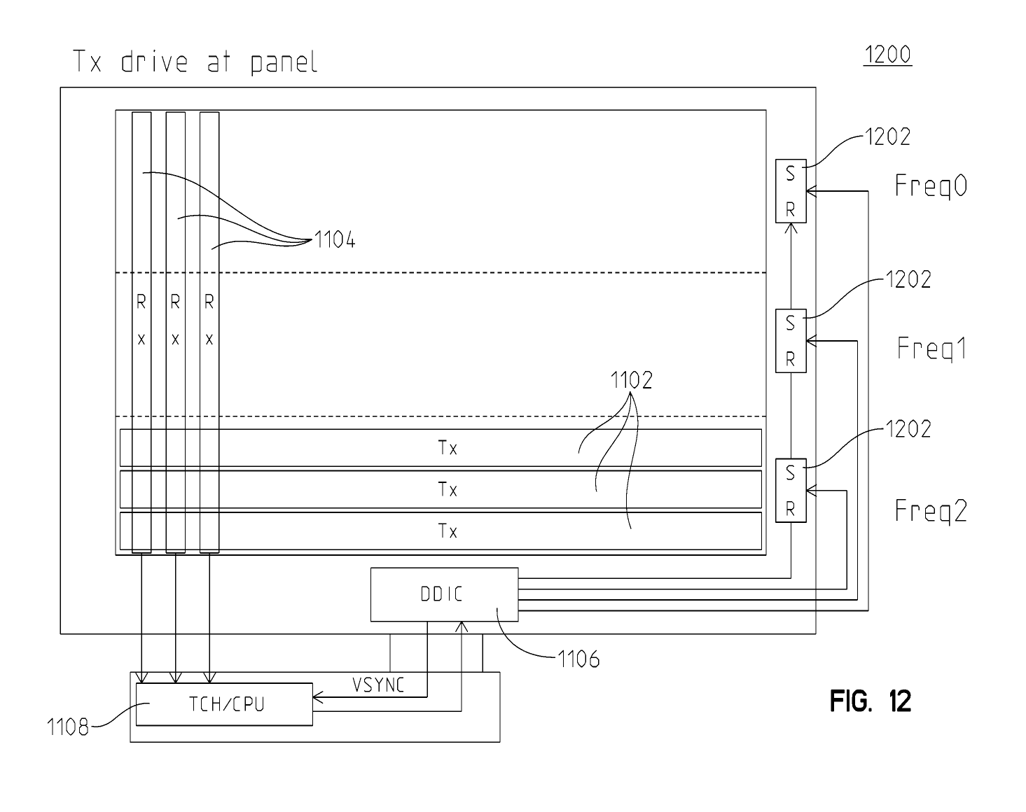

FIG. 12 illustrates an exemplary multi-frequency transmitter electrode driving scheme 1200 at the display panel using the full in-cell system according to one or more examples of the present disclosure. For instance, the driving scheme 1200 may be similar to the driving scheme 500 of FIG. 5 except that because the Rx electrodes 1104 are within the display cell 975, a flexible printed circuit (FPC) might not be needed. Otherwise, the driving schemes 500 and 1200 may function similarly.

For instance, instead of the touch controller 1108 driving the Tx electrodes 1102, in the driving scheme 1200, the DDIC 1106 may drive the Tx electrodes 1102. For example, the touch controller 1108 and the DDIC 1106 may communicate with each other such as by providing Vsync signals and/or other information. Furthermore, the DDIC 1106 may drive the Tx electrodes 1102 at different frequencies.

In addition, for the driving scheme 1200, the input device 920 may further include one or more shift registers (SR) 1202. For example, the shift registers 1202 may be configured to drive the Tx electrodes 1102 within each subset sequentially. For instance, based on the input device 920 including nine Tx electrodes 1102 that are separated into three subsets of Tx electrodes, the DDIC 1106 may use the shift registers 1202 to drive the three subsets of Tx electrodes 1102 using different frequencies. For example, in a first frame, the DDIC 1106 may drive a first Tx electrode from each of the three subsets of Tx electrodes 1102 using the three different frequencies (e.g., a first Tx electrode from the first subset may be driven using a first frequency, a first Tx electrode from the second subset using a second frequency, and a first Tx electrode from the third subset using a third frequency). Then, in a second frame, the DDIC 1106 may drive a second Tx electrode from each of the three subsets of Tx electrodes 1102 using the three different frequencies (e.g., a second Tx electrode from the first subset may be driven using a first frequency, a second Tx electrode from the second subset using a second frequency, and a second Tx electrode from the third subset using a third frequency). In the third frame, the DDIC 1106 may drive a third Tx electrode from each of the three subsets of Tx electrodes 1102 using the three different frequencies.

FIGS. 13A-13B illustrate additional multi-frequency transmitter electrode driving schemes 1300 and 1320 using the full in-cell system according to one or more examples of the present disclosure. For instance, the driving schemes 1300 and 1320 may be similar to the driving schemes 700 and 720 of FIGS. 7A and 7B except that because the Rx electrodes are within the display cell 975, a flexible printed circuit (FPC) might not be needed. Additionally, and/or alternatively, patterned Rx sensors on the color filter glass layer 940 might not be necessary, which may be a significant benefit of the full in-cell system described above as compared to the hybrid in-cell system. Otherwise, the driving schemes 1300 and 700 as well as 1320 and 720 may function similarly.

For instance, referring to FIG. 13A, the driving scheme 1300 may be similar to the multi-frequency direct transmitter electrode driving scheme 1100 except that more than three frequencies are used to drive the Tx electrodes 1302. For example, instead of using three frequencies and as mentioned above, additional frequencies (e.g., the six frequencies are used, which further includes “Freq3”, “Freq4”, and “Freq5”). For instance, instead of separating the Tx electrodes 1302 into three subsets, in FIG. 13A, the Tx electrodes 1302 are separated into six subsets. Furthermore, instead of having one touch controller, the input device 920 for the driving scheme 1300 may include two touch controllers 1308-1310 (e.g., the TCH/CPU). The first touch controller 1308 may be configured to drive three subsets of Tx electrodes 1302 and the second touch controller 1310 may be configured to drive the other three subsets of Tx electrodes 1302. While two touch controllers 1308-1310 are shown, in some examples, a single touch controller or more than two touch controllers may be used to drive the six subsets of Tx electrodes 1302. Furthermore, while six frequencies and six subsets of Tx electrodes 1302 are shown, in other examples, a different number of frequencies and/or subsets of Tx electrodes 1302, including the number of Tx electrodes 1302 within each subset, may be used. In addition, similar to the above, FIG. 13A also shows the Rx electrodes 1304 and the DDIC 1306.

In some examples, instead of having two touch controllers 1308-1310 drive the Tx electrodes, the DDIC 1306 (and/or multiple DDICs) may be used to drive the Tx electrodes 1302, which is described above. In some variations, instead of the horizontal Tx electrodes 1302, the multi-frequency transmitter electrode driving scheme 1300 may be applied to vertical Tx electrodes, which is described above.

Referring to FIG. 13B, the driving scheme 1320 may be similar to the driving scheme 1100 except that there may be additional regions and subsets that are driven with different frequencies. For example, as shown, an input device may have a larger display screen such that two Tx electrodes would be included in each row. To put it another way, for the sensor arrangement shown in FIG. 13B, the input device 920 may include a plurality of rows of horizontal Tx electrodes 1302, and each row may include two Tx electrodes. As such, the input device 920 may include two columns of Tx electrodes 1302, with each column driven by a respective touch controller 1308-1310 (e.g., the TCH/CPU). Each row including two Tx electrodes is merely exemplary and additional Tx electrodes may be included within each row. Furthermore, two columns of Tx electrodes are merely exemplary and more than two columns of Tx electrodes may be included.

In operation, the Tx electrodes 1302 may be separated into subsets. For example, a first column of Tx electrodes 1302 may be separated into three subsets (e.g., a first, second, and third subset) and a second column of Tx electrodes 1302 may be separated into three additional subsets (e.g., a fourth, fifth, and sixth subset). The touch controller(s) 1308-1310 may be configured to drive the subsets of Tx electrodes 1302 using different frequencies (e.g., using six frequencies), which is described above. In some instances, two touch controllers 1308-1310 are used for the driving scheme 1320. The first touch controller 1308 may be configured to drive the first column of Tx electrodes 1302 and the second touch controller 1310 may be configured to drive the second column of Tx electrodes 1302. In other instances, a single touch controller or more than two touch controllers may be configured to drive the Tx electrodes. In yet other instances, the DDIC or multiple DDICs may be configured to drive the Tx electrodes, which is described above. For instance, as shown, two DDICs 1312-1314 may be used.

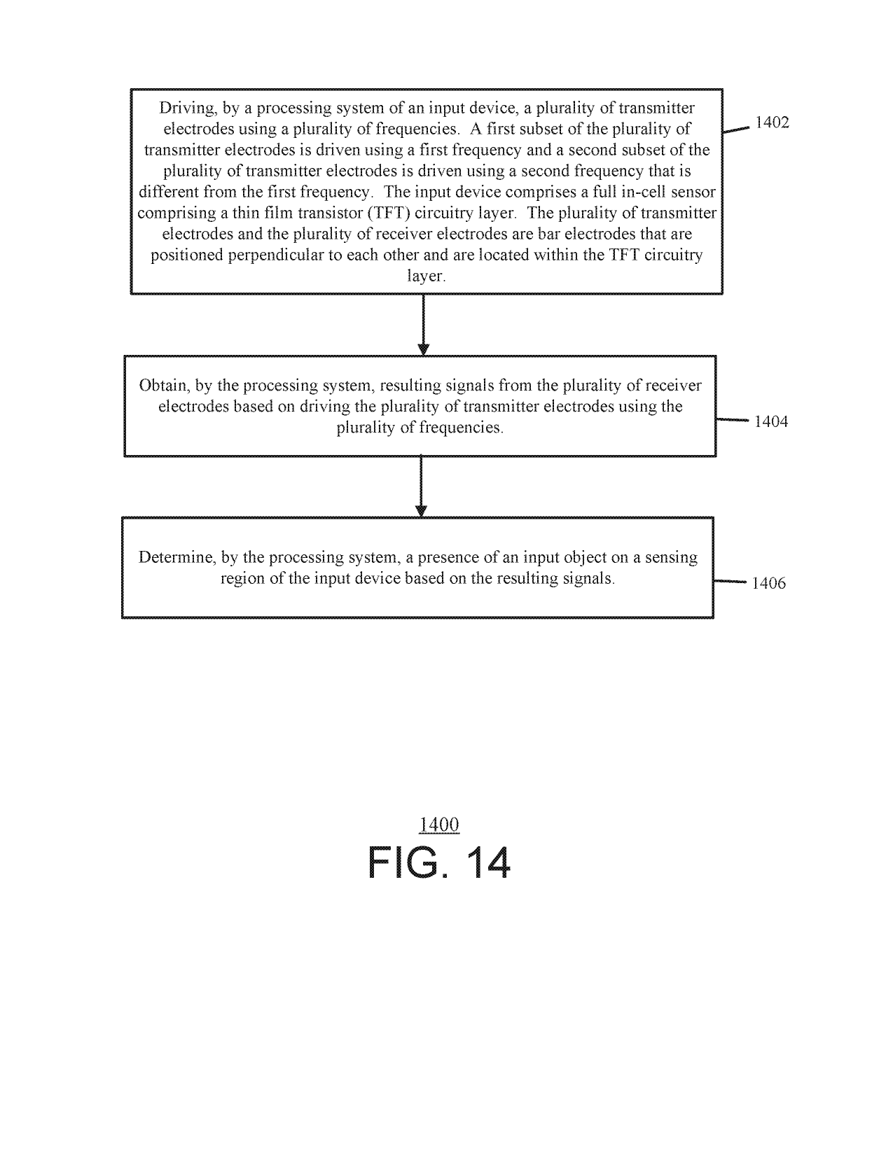

FIG. 14 depicts another exemplary flowchart performing a multi-frequency transmitter electrode driving scheme according to one or more examples of the present disclosure. The process 1400 may be performed by the input device 100 and, in particular, the processing system 110 shown in FIG. 1. For instance, as mentioned above, the input device 100 may be the input device 920 and may include a full in-cell system that is capable of performing a transcapacitive sensing scheme. However, it will be recognized that an input device that includes additional and/or fewer components as shown in FIG. 1 may be used to perform process 1400, that any of the following blocks may be performed in any suitable order, and that the process 1400 may be performed in any suitable environment. The descriptions, illustrations, and processes of FIG. 14 are merely exemplary and the process 1400 may use other descriptions, illustrations, and processes for performing the multi-frequency transmitter electrode driving scheme.

For example, at block 1402, the processing system 110 of the input device 100 may drive a plurality of Tx electrodes using a plurality of frequencies. A first subset of the plurality of Tx electrodes is driven using a first frequency and a second subset of the plurality of Tx electrodes is driven using a second frequency that is different from the first frequency. The input device comprises a full in-cell sensor comprising a TFT circuitry layer 955. The plurality of transmitter electrodes and the plurality of receiver electrodes are bar electrodes that are positioned perpendicular to each other and are located within the TFT circuitry layer 955. For example, the processing system 110 may use the driving schemes described in FIGS. 11-13B to drive the plurality of Tx electrodes of the input device 920 that includes the full in-cell system (e.g., the full in-cell system described by FIG. 9B).

At block 1404, the processing system 110 may obtain resulting signals from the plurality of receiver electrodes based on driving the plurality of transmitter electrodes using the plurality of frequencies. At block 1406, the processing system 110 may determine a presence of an input object on a sensing region of the input device based on the resulting signals.

As used herein, including in the claims, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An input device for performing a multi-frequency transmitter electrode driving scheme, comprising:
a hybrid in-cell sensor comprising:
a thin film transistor (TFT) glass layer and a color filter glass layer;
a plurality of transmitter electrodes that are positioned on a first side of the TFT glass layer; and
a plurality of receiver electrodes that are positioned on a first side of the color filter glass layer; and
a processing system configured to:
drive the plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency;
obtain resulting signals from the plurality of receiver electrodes based on driving the plurality of transmitter electrodes using the plurality of frequencies; and
determine a presence of an input object on a sensing region of the input device based on the resulting signals.

2. The input device of claim 1, wherein the hybrid in-cell sensor further comprises:
TFT circuitry, wherein the plurality of transmitter electrodes are within the TFT circuitry and wherein the plurality of receiver electrodes are deposited on the first side of the color filter glass layer.

3. The input device of claim 2, wherein the hybrid in-cell sensor further comprises:
a liquid crystal (LC) material layer that is positioned between the TFT glass layer and the color filter glass layer.

4. The input device of claim 1, wherein the processing system comprises one or more touch controllers, wherein the one or more touch controllers are configured to drive the plurality of transmitter electrodes using the plurality of frequencies in a same frame.

5. The input device of claim 4, wherein a first touch controller of the one or more touch controllers is configured to drive the plurality of transmitter electrodes using the plurality of frequencies by:
driving the first subset of the plurality of transmitter electrodes using the first frequency in the frame;
driving the second subset of the plurality of transmitter electrodes using the second frequency in the frame; and
driving a third subset of the plurality of transmitter electrodes using a third frequency in the frame.

6. The input device of claim 5, wherein a second touch controller of the one or more touch controllers is configured to drive the plurality of transmitter electrodes using the plurality of frequencies by:
driving a fourth subset of the plurality of transmitter electrodes using a fourth frequency in the frame;
driving a fifth subset of the plurality of transmitter electrodes using a fifth frequency in the frame; and
driving a sixth subset of the plurality of transmitter electrodes using a sixth frequency in the frame.

7. The input device of claim 6, wherein the plurality of transmitter electrodes are separated into a first column of transmitter electrodes and a second column of transmitter electrodes such that each row of the plurality of transmitter electrodes comprises a transmitter electrode from the first column of transmitter electrodes and a transmitter electrode from the second column of transmitter electrodes, wherein the first column of transmitter electrodes comprises the first subset, the second subset, and the third subset, and wherein the second column of transmitter electrodes comprises the fourth subset, the fifth subset, and the sixth subset.

8. The input device of claim 1, wherein the processing system comprises one or more display driver integrated circuits (DDICs), wherein the one or more DDICs are configured to drive the plurality of transmitter electrodes using the plurality of frequencies.

9. The input device of claim 8, wherein a DDIC of the one or more DDICs is configured to drive the plurality of transmitter electrodes using the plurality of frequencies by:
driving the first subset of the plurality of transmitter electrodes using the first frequency;
driving the second subset of the plurality of transmitter electrodes using the second frequency; and
driving a third subset of the plurality of transmitter electrodes using a third frequency.

10. The input device of claim 9, further comprising:
a plurality of shift registers that are configured to sequentially drive a single transmitter electrode from each of the first subset, the second subset, and the third subset, wherein each of the plurality of transmitter electrodes comprises a first end and a second end, and wherein a first shift register, of the plurality of shift registers, is electrically connected to the first end of the first subset of the plurality of transmitter electrodes and the DDIC.

11. The input device of claim 10, wherein a second shift register, of the plurality of shift registers, is electrically connected to the second end of the second subset of the plurality of transmitter electrodes and the DDIC.

12. The input device of claim 1, wherein the plurality of transmitter electrodes and the plurality of receiver electrodes are bar electrodes that are oriented perpendicular to each other.

13. The input device of claim 12, wherein the plurality of transmitter electrodes is oriented in a horizontal direction and the plurality of receiver electrodes is oriented in a vertical direction.

14. The input device of claim 12, wherein the plurality of transmitter electrodes is oriented in a vertical direction and the plurality of receiver electrodes is oriented in a horizontal direction.

15. A method for performing a multi-frequency transmitter electrode driving scheme, comprising:
driving, by a processing system of an input device, a plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency, wherein the input device comprises a hybrid in-cell sensor comprising a thin film transistor (TFT) glass layer and a color filter glass layer, and wherein the plurality of transmitter electrodes are positioned on a first side of the TFT glass layer and a plurality of receiver electrodes are positioned on a first side of the color filter glass layer;
obtaining, by the processing system, resulting signals from the plurality of receiver electrodes based on driving the plurality of transmitter electrodes using the plurality of frequencies; and
determining, by the processing system, a presence of an input object on a sensing region of the input device based on the resulting signals.

16. The method of claim 15, wherein the hybrid in-cell sensor further comprises TFT circuitry and a liquid crystal (LC) material layer, wherein the plurality of transmitter electrodes are within the TFT circuitry and the plurality of receiver electrodes are deposited on the first side of the color filter glass layer, and wherein the LC material layer is positioned between the TFT glass layer and the color filter glass layer.

17. The method of claim 15, wherein the processing system comprises one or more touch controllers, wherein driving the plurality of transmitter electrodes using the plurality of frequencies comprises driving, using the one or more touch controllers, the plurality of transmitter electrodes using the plurality of frequencies in a same frame.

18. The method of claim 17, wherein driving, using the one or more touch controllers, the plurality of transmitter electrodes using the plurality of frequencies in the same frame comprises:
driving the first subset of the plurality of transmitter electrodes using the first frequency in the frame;
driving the second subset of the plurality of transmitter electrodes using the second frequency in the frame; and
driving a third subset of the plurality of transmitter electrodes using a third frequency in the frame.

19. The method of claim 15, wherein the processing system comprises one or more display driver integrated circuits (DDICs), wherein driving the plurality of transmitter electrodes using the plurality of frequencies comprises driving, using the one or more DDICs, the plurality of transmitter electrodes using the plurality of frequencies.

20. A non-transitory computer-readable medium having processor-executable instructions stored thereon for performing a multi-frequency transmitter electrode driving scheme, wherein the processor-executable instructions, when executed, facilitate:
driving, using a processing system of an input device, a plurality of transmitter electrodes using a plurality of frequencies, wherein a first subset of the plurality of transmitter electrodes is driven using a first frequency and a second subset of the plurality of transmitter electrodes is driven using a second frequency that is different from the first frequency, wherein the input device comprises a hybrid in-cell sensor comprising a thin film transistor (TFT) glass layer and a color filter glass layer, and wherein the plurality of transmitter electrodes are positioned on a first side of the TFT glass layer and a plurality of receiver electrodes are positioned on a first side of the color filter glass layer;
obtaining resulting signals from the plurality of receiver electrodes based on driving the plurality of transmitter electrodes using the plurality of frequencies; and
determining a presence of an input object on a sensing region of the input device based on the resulting signals.
